(19) United States
(12) Patent Application Publication
(10) Pub. No.: US 2021/0060484 A1
(43) Pub. Date: Mar. 4, 2021

(54) PROTON COUPLED ELECTROCHEMICAL CO2 CAPTURE SYSTEM

(71) Applicant: President and Fellows of Harvard College, Cambridge, MA (US)

(72) Inventors: Michael J. AZIZ, Cambridge, MA (US); David Gator KWABI, Somerville, MA (US)

(21) Appl. No.: 16/960,221

(22) PCT Filed: Jan. 7, 2019
(86) PCT No.: PCT/US2019/012534

§ 371 Date: Jul. 6, 2020

Related U.S. Application Data
(60) Provisional application No. 62/614,308, filed on Jan. 5, 2018.

(51) Int. Cl. B01D 53/32

(52) U.S. Cl. CPC B01D 53/326

(57) ABSTRACT

The invention provides an electrochemical CO₂ capture device and methods employing proton-coupled redox active species, e.g., a quinone, phenazine, alloxazine, isoalloxazine, or polyoxometalate, whose protonation and deprotonation can be controlled electrochemically to modify the pH of an aqueous solution or aqueous suspension. This change in pH can be used to sequester and release CO₂. The CO₂ capture device can be used to sequester gaseous CO₂ from a point source, such as flue gas, or from ambient air.

### FIELD OF THE INVENTION

The invention is directed to the field of electrochemical capture and release of CO₂ gas.

### BACKGROUND OF THE INVENTION

The accumulation of CO₂ emissions from the burning of fossil fuels has resulted in a historically unprecedented rate of climate change [1]. Consequently, there are increasing efforts worldwide to reduce societal reliance on fossil fuel-based energy and to switch to carbon-free sources such as nuclear, solar, wind and geothermal [2]. According to the IPCC, average atmospheric CO₂ concentrations have to stay below roughly 500 ppm in order to avoid severe consequences of global warming (greater than 2° C. above pre-industrial era levels) and irreversibly deleterious changes to natural habitats and ecosystems that would threaten the viability of human civilization [3]. Given that the global rate of transition to low-carbon sources is presently not nearly fast enough to avoid this threshold, other approaches are urgently required to deal with the problem of rising CO₂ emissions.

Among these is carbon capture and sequestration (CCS), in which CO₂ is separated from a point source [4] (e.g., flue gas from a coal/natural gas power plant), compressed, and sequestered away from the atmosphere in any of a variety of final resting places. A variant on this idea is air capture [5], in which CO₂ is captured directly from ambient air, compressed, and sequestered. These approaches combat the rise in atmospheric CO₂ levels while recognizing that fossil fuel combustion cannot be turned off rapidly enough for the climate to stabilize.

CO₂ separation from mixed gases is the most energetically demanding step of CCS, and much research effort has gone into developing separation techniques that expend as little energy as possible per ton of CO₂ captured. The most well-developed means for doing so to date are “temperature-swing” cycles that involve contacting CO₂ with a strongly alkaline chemical sorbent in an absorption step and then heating the CO₂-rich sorbent to release pure CO₂. The overall energy input required for the temperature-swing, however, is high (115-140 kJ/mol_{CO2}) as compared to the minimum thermodynamic requirement for carbon capture from air (20 kJ/mol_{CO2}) or flue gas with 10% CO₂ (6 kJ/mol_{CO2}) [6]. It is worth noting that CCS from flue gas with sorbents in a temperature-swing CO₂ capture cycle would require roughly 30% of the heat energy produced from combustion to be consumed by carbon capture [4], thereby making it unavailable for electricity production.

The use of hydroxide (OH⁻) ions in alkaline aqueous salt solutions to capture CO₂, in the reactions:

OH⁻+CO₂→HCO₃⁻ (1)

and, subsequently:

HCO₃⁻+OH⁻→CO₃²⁻+H₂O (2)

has received renewed interest in recent years as part of a viable separation approach. For example, direct air capture (DAC) using strongly alkaline (e.g., 1 M) NaOH solutions to absorb CO₂ in a high-surface-area contactor and a chemical regeneration cycle that uses thermal energy to subsequently release it from solid precipitates have been developed [7,8]. This process has an only modestly lower energetic cost (105 kJ/mol_{CO2}) than sorbents with temperature-swing (115-140 kJ/mol_{CO2}). This process has an energetic cost that is comparable to that of many temperature-swing-based processes, but its potentially low financial cost ($94-$232/ton_{CO2}) for DAC makes practical application on a wide scale more feasible [8].

Accordingly, there is a need for new devices and methods for CCS.

### SUMMARY OF THE INVENTION

We provide a new electrochemically-mediated CO₂ separation approach that uses large changes in solution pH to absorb and release CO₂ and requires electrical, but no thermal, energy input. This approach relies on proton-coupled electron transfer (PCET) in an aqueous salt solution, i.e., electrochemical reduction/oxidation (“redox”) of these molecules results in proton uptake/release, respectively [7-13]. Electrochemical redox involving PCET results in changes in solution pH which can cause CO₂ to be strongly absorbed at high pH (>12) and released at low pH (<5) [14].

In one aspect, the invention features a device for capturing CO₂ including a liquid flow path including a) a first region having a first inlet and a first outlet and an aqueous solution or suspension including a proton-coupled redox active species, where the first region is configured to receive a gas containing CO₂ via the first inlet, allow the gas to contact the aqueous solution or suspension, and to release the gas depleted of CO₂ via the first outlet; b) a second region fluidically connected to the first region and having at least one electrode; c) a third region fluidically connected to the second region and having a second outlet, where the third region is configured to release CO₂ outgassing from the aqueous solution or suspension via the second outlet; and d) a fourth region fluidically connected to the first and third regions and having at least one electrode. Oxidation of the proton-coupled redox active species releases one or more protons to decrease the pH of the aqueous solution or suspension, and reduction of the proton-coupled redox active species takes up one or more protons to increase the pH of the aqueous solution or suspension.

In certain embodiments, the device further includes at least one ion-conducting barrier, e.g., disposed between the second and fourth regions. In other embodiments, the third region further includes a second inlet fluidically connected to the second outlet, where the second inlet is connected to a carrier gas source. In one embodiment, the pH in the third region is less than 8, e.g., less than 7, and/or the pH in the first region is greater than 7, e.g., greater than 8. The proton-coupled redox active species is present, for example, in the aqueous solution or suspension at a concentration of at least 0.5 M. In certain embodiments, the oxidized form of the proton-coupled redox active species is a quinone, phenazine, alloxazine, isoalloxazine, or polyoxometalate.

In some embodiments, the device includes an electrochemical cell. In certain embodiments, the device includes a plurality of electrochemical cells.

In a related aspect, the invention features a method of capturing CO₂ by providing an aqueous solution or suspension comprising a proton-coupled redox active species and having a first pH; allowing a gas containing CO₂ to contact the aqueous solution or suspension under conditions for the CO₂ to dissolve into the aqueous solution or suspension; converting, e.g., decreasing or increasing, the pH of the aqueous solution or suspension to a second pH by oxidizing the proton-coupled redox active species; allowing the dissolved CO₂ to outgas from the aqueous solution or suspension; and converting, e.g., decreasing or increasing, the pH of the aqueous solution or suspension to a third pH by reducing the proton-coupled redox active species. In certain embodiments, the first pH is decreased to the second pH, and the second pH is increased to the third pH in the method.

This method may be carried out in any device of the invention. In certain embodiments, the CO₂ is captured from a point source or ambient air. In some embodiments, the first pH is greater than 7; the second pH is less than 8, e.g., less than 7; and/or the third pH is greater than 6, e.g., greater than 7. The second pH may be converted to the third pH in a single step or in two or more steps. The method may operate continuously or sequentially. In certain embodiments, the oxidized form of the proton-coupled redox active species is a quinone, phenazine, alloxazine, isoalloxazine, or polyoxometalate. In other embodiments, the oxidizing and/or reducing are carried out electrochemically.

### Definitions

By “alkyl” is meant straight chain or branched saturated groups from 1 to 10 carbons, e.g., 1 to 6 carbon. Alkyl groups are exemplified by methyl, ethyl, n- and iso-propyl, n-, sec-, iso- and tert-butyl, neopentyl, and the like, and may be optionally substituted with one or more, substituents.

By “alkyl ester” is meant an optionally substituted alkyl group substituted with a group of formula C(O)ORₐ, wherein Rₐ is optionally substitute alkyl.

By “aryl” is meant an aromatic cyclic group in which the ring atoms are all carbon. Exemplary aryl groups include phenyl, naphthyl, and anthracenyl. Aryl groups may be optionally substituted with one or more substituents.

By “carbocyclyl” is meant a non-aromatic cyclic group in which the ring atoms are all carbon. Exemplary carbocyclyl groups include cyclopropyl, cyclobutyl, cyclopentyl, cyclohexyl, cycloheptyl, and cyclooctyl. Carbocyclyl groups may be optionally substituted with one or more substituents.

By “halo” is meant, fluoro, chloro, bromo, or iodo.

By “oxo” is meant ═O.

By “heteroaryl” is meant an aromatic cyclic group in which the ring atoms include at least one carbon and at least one O, N, or S atom, provided that at least three ring atoms are present. Exemplary heteroaryl groups include oxazolyl, isoxazolyl, tetrazolyl, pyridyl, thienyl, furyl, pyrrolyl, imidazolyl, pyrimidinyl, thiazolyl, indolyl, quinolinyl, isoquinolinyl, benzofuryl, benzothienyl, pyrazolyl, pyrazinyl, pyridazinyl, isothiazolyl, benzimidazolyl, benzothiazolyl, benzoxazolyl, oxadiazolyl, thiadiazolyl, and triazolyl. Heteroaryl groups may be optionally substituted with one or more substituents.

By “heterocyclyl” is meant a non-aromatic cyclic group in which the ring atoms include at least one carbon and at least one O, N, or S atom, provided that at least three ring atoms are present. Exemplary heterocyclyl groups include epoxide, thiiranyl, aziridinyl, azetidinyl, thietanyl, dioxetanyl, morpholinyl, thiomorpholinyl, piperazinyl, piperidinyl, pyrrolidinyl, tetrahydropyranyl, tetrahydrofuranyl, dihydrofuranyl, tetrahydrothienyl, dihydrothienyl, dihydroindolyl, tetrahydroquinolyl, tetrahydroisoquinolyl, pyranyl, pyrazolinyl, pyrazolidinyl, dihydropyranyl, tetrahydroquinolyl, imidazolinyl, imidazolidinyl, pyrrolinyl, oxazolidinyl, isoxazolidinyl, thiazolidinyl, isothiazolidinyl, dithiazolyl, and 1,3-dioxanyl. Heterocyclyl groups may be optionally substituted with one or more substituents.

By “liquid flow path” is meant a structure capable of holding and allowing a liquid, e.g., water, to circulate.

By “proton-coupled redox active species” is meant a molecule that can be deprotonated or protonated via oxidation-reduction reactions. Exemplary proton coupled redox active species are organic molecules such as a quinone, phenazine, alloxazine, isoalloxazine, or polyoxometalate.

As noted, substituents may be optionally substituted with one or more of halo, optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; optionally substituted —[X—(CH₂)ₙ]ₘ—CH₃ (wherein m is 1 to 10, e.g., 1 to 5; each n is independently 1-6, e.g., 1-3; and each X is independently O or S); -oxo; —CN; —NO₂; —ORₐ; —SRₐ; —N(Rₐ)₂; —C(═O)Rₐ; —C(═O)ORₐ; —S(═O)₂Rₐ; —S(=)₂ORₐ; —P(═O)Rₐ₂; —O—P(═O)(ORₐ)₂, or —P(═O)(ORₐ)₂, or an ion thereof; wherein each Rₐ is independently H, C₁₋₁₀ alkyl (e.g., C₁₋₆ alkyl); optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group. Cyclic substituents may also be substituted with C₁₋₁₀ alkyl (e.g., C₁₋₆ alkyl).

Exemplary ions of substituent groups are as follows: an exemplary ion of —OH is —O⁻; an exemplary ion of —COOH is —COO⁻; exemplary ions of —PO₃H₂ are —PO₃H⁻ and —PO₃²⁻; an exemplary ion of —PO₃HRₐ is —PO₃Rₐ⁻, where Rₐ is not H; exemplary ions of —PO₄H₂ are —PO₄H⁻ and —PO₄²⁻; and exemplary ion of —NRₐ₂ is —NRₐ₂H⁺, and an exemplary ion of —SO₃H is —SO₃⁻.

### BRIEF DESCRIPTION OF THE DRAWINGS

FIGS. 1A-1B: (A) Scheme of single cell electrochemical device for PCET-mediated CO₂ separation highlighting the four regions of the process, including acidification of an aqueous salt solution (1→2), outgassing of CO₂ (2→3), de-acidification of the aqueous salt solution (3→4), and invasion of CO₂ (4→1). (B) Schematic of a two-membrane electrochemical cell, showing how electrochemical acidification and de-acidification processes are integrated with CO₂ outgassing and invasion. A KCl supporting salt is assumed, and K⁺ and Cl⁻ ions move through the cation exchange membrane (CEM) and anion exchange membrane (AEM), respectively, to/from a middle electrolyte chamber. Mo and MR, represent the redox processes occurring counter to Q/QH₂, and could be either symmetric (i.e., QH₂/Q) or asymmetric (i.e., employing some other redox couple), the latter case implying that CCS could be integrated with energy storage.

FIG. 2: Electrical potential versus pH for a quinone dissolved in an aqueous salt solution.

FIGS. 3A-3B: (A) Dependence of the pH as a function of the concentration of an oxidized quinone. (B) Dependence of the pH as a function of the concentration of a reduced quinone.

FIGS. 4A-4B: (A) Dissolved inorganic carbon (DIC) and pH as a function of total alkalinity (TA) at a CO₂ partial pressure of 0.1 bar. (B) Dissolved inorganic carbon (DIC) and pH as a function of total alkalinity (TA) at a CO₂ partial pressure of 400 ppm.

FIG. 5: Minimum concentration of QH₂ required to convert 99% of all DIC to CO₂(aq).

FIGS. 6A-6D: (A) pH as a function of Q, QH₂, and CO₂(aq) concentrations for an ideal CO₂ separation cycle during the electrochemical acidification (process 1→2). (B) pH as a function of Q, QH₂, and CO₂(aq) concentrations for an ideal CO₂ separation cycle during CO₂ outgassing at 1 bar CO₂(g) (process 2→3). (C) pH as a function of Q, QH₂, and C₂(aq) concentrations for an ideal CO₂ separation cycle during the electrochemical de-acidification (process 3→4). (D) pH as a function of Q, QH₂, and CO₂(aq) concentrations for an ideal CO₂ separation cycle during CO₂ invasion (process 4→1), at the end of which aqueous CO₂ (CO₂(aq)) is assumed to be in equilibrium with 0.1 bar CO₂ gas. For this cycle, a starting value of [QH₂] of 1.4 M and a DIC value at State 1 of 2.46 M are assumed.

FIG. 7: DIC vs. pH during the 4-process cycle described in FIGS. 7A-7D. At each numbered state, DIC, [CO₂(aq)], and equilibrium CO₂(g) corresponding to the value of [CO₂(aq)] are reported.

FIG. 8: CO₂(aq) vs. pH during the 4-process cycle described in FIGS. 6A-6D. The equilibrium CO₂ pressure corresponding to each CO₂(aq) is stated.

FIGS. 9A-9D: Ideal CO₂ separation cycle for starting QH₂ concentration of 0.1 M, DIC concentration of 0.175 M and an exit/inlet pressure ratio of 10, which translates to an outgassing overpressure of 5. (A) pH as a function of Q and QH₂ concentration and CO₂(aq) during the electrochemical acidification (process 1→2). (B) pH as a function of Q and QH₂ concentration and CO₂(aq) during CO₂ outgassing (process 2→3). (C) pH as a function of Q and QH₂ concentration and CO₂(aq) during the electrochemical de-acidification (process 3→4). (D) pH as a function of Q and QH₂ concentration and CO₂(aq) during CO₂ invasion (process 4→1), at the end of which aqueous CO₂ (CO₂(aq)) is assumed to be in equilibrium with 0.1 bar CO₂ gas.

FIG. 10: Relationship between outgassing overpressure and exit/inlet pressure ratio for various [QH₂] values at State 1 between 0.1 and 8.0 M, assuming the solution at State 1 is in equilibrium with 0.1 bar CO₂ gas.

FIG. 11: Redox potential as a function of Q concentration during electrochemical acidification (process 1→2) and de-acidification (process 3→4) for the ideal CO₂ separation cycle of FIG. 7.

FIGS. 12A-12B: (A) Ideal cycle work as a function of the exit/inlet pressure ratio, p₃/p₁, for various values of the outgassing overpressure, p₂/p₃, for an inlet stream of 0.1 bar CO₂. (B) Ideal cycle work as a function of the exit/inlet pressure ratio, p₃/p₁, for various values of the outgassing overpressure, p₂/p₃, for an inlet stream 400 ppm CO₂. In both (A) and (B), exit/inlet pressure ratios around 2500 are plotted as this is relevant to DAC, where CO₂ is separated from 400 ppm to 1 bar. Both measures are compared against the minimum work of separation at each exit/inlet pressure ratio.

FIGS. 13A-13B: (A) Redox potential vs Q concentration during ideal cycle both without and with two-stage acidification. (B) DIC vs pH during ideal cycle both without and with two-stage acidification. In both (A) and (B), electrochemical acidification is performed in two stages: acidification at constant DIC up to [CO₂(aq)]=35 mM, followed by outgassing and further acidification in tandem at constant [CO₂(aq)] until [Q] reaches 1.4 M.

FIGS. 14A-14B: (A) Ideal cycle work vs exit/inlet pressure ratios for an inlet stream at 0.1 bar CO. (B) Ideal cycle work vs exit/inlet pressure ratios for an inlet stream at 400 ppm CO₂. For both (A) and (B), the highest exit/inlet pressure ratio represents an exit pressure of 150 bar CO₂(g), and the maximum overpressure plotted in each case is based on the assumption that QH₂ concentration can reach up to 10 M.

FIG. 15: Ideal CO₂ capture cycle electrical energy work input (in kJ/mol_{CO2}) for CO₂ separation from flue gas (10% CO₂) and air (400 ppm CO₂) to a pure ˜1 bar CO₂ stream vs. CO₂ supersaturation compared to the thermodynamic minimum work of separation. Supersaturation is defined as the ratio of aqueous CO₂ after the acidification step (1→2) compared to its equilibrium concentration at a pressure of 1 atmosphere. Higher supersaturation results in a higher CO₂ separation throughput but also higher energy cost.

FIG. 16: Relationship between pKₐ of Q and final pH upon reduction of Q based on the solution to implicit equation 15 for a series of Q concentrations between 50 mM and 2.0 M.

### DETAILED DESCRIPTION OF THE INVENTION

The invention provides an electrochemical CO₂ capture device employing proton-coupled redox active species whose protonation and deprotonation can be controlled electrochemically to modify the pH of an aqueous solution or aqueous suspension. This change in pH can be used to sequester and release CO₂. The CO₂ capture device can be used to sequester gaseous CO₂ from a point source, such as flue gas, or from ambient air. The total possible amount of sequestered carbon, the Dissolved Inorganic Carbon (DIC), depends on the partial pressure of CO₂ above the aqueous solution or aqueous suspension, and the pH determines the form of the carbon, e.g., dissolved CO₂, HCO₃ or CO₃²⁻. CO₂ can be captured from a gaseous source, e.g., point sources or ambient air, by dissolving into an aqueous solution. More CO₂ can be dissolved as the pH of the aqueous solution or aqueous suspension increases, resulting in the conversion of CO₂ into HCO₃⁻ or CO₃²⁻ ions. More CO₂ can be dissolved in an aqueous solution or aqueous suspension as HCO₃⁻ or CO₃²⁻ than CO₂, resulting in supersaturation of CO₂ in the aqueous solution or aqueous suspension. Once captured, the CO₂ can be released by acidifying the aqueous solution or aqueous suspension. In principle, the pure CO₂ obtained after separation can be converted back into useful chemical fuels and feedstocks with carbon-free energy, thus providing fuels and feedstocks without added CO₂ emissions.

### Fundamentals of pH Changes Using Proton Coupled Electron Transfer (PCET)

In order to effect large changes in solution pH using PCET in aqueous media containing CO₂, buffering from inorganic carbon species must be overcome. Thus, we first examine the dependence of pH on the constituents of dissolved inorganic carbon (DIC) species present in solution, namely aqueous CO₂ (CO₂(aq)), bicarbonate (HCO₃—) and carbonate (CO₃²⁻) [15]:

DIC=[CO₂(aq)]+[HCO₃]+[CO₃²⁻]. (1)

The relative ratios of these species at equilibrium is dictated by the reactions between aqueous CO₂ and water:

CO₂(aq)+H₂O [symbol] HCO⁻₃+H⁺ [symbol] CO₃²⁻+2H⁺

where K₁ and K₂ are the first and second dissociation constants of carbonic acid (H₂CO₃), respectively, and defined as the following equilibrium constants:

$$\begin{matrix}{K}_{1} = \frac{[ {HCO}_{3}^{-} ] [ {H}^{+} ]}{[ {CO}_{2} ( aq ) ]} ; & ( 2 ) \\ {K}_{2} = \frac{[ {CO}_{3}^{2 -} ] [ {H}^{+} ]}{[ {HCO}_{3}^{-} ]} . & ( 3 )\end{matrix}$$

For a solution of zero salinity, K₁ and K₂ are 1.1×10⁻⁶ M and 4.1×10⁻¹⁰ M [16], resulting in the first and second pKₐ for carbonic acid being 6.0 and 9.4, respectively. Thus, in acidic solutions of pH<6 total DIC is composed primarily of dissolved CO₂(aq), in basic solutions of pH>9.4 total DIC is composed primarily of carbonate anions, and for the intermediate pH range total DIC is composed primarily of bicarbonate anions.[15] Because CO₂(aq), being uncharged, is the only form that exchanges with the atmosphere, increasing the pH of a solution drives down the activity of CO₂(aq), leading to net dissolution of CO₂(g) as CO₂(aq). Correspondingly, decreasing the pH raises the activity of CO₂(aq), leading to outgassing. This provides a mechanism for selectively absorbing CO₂ from a mixture of gases, and then releasing a pure stream at a separate point for sequestration. Given that certain bicarbonate/carbonate compounds have exceptionally high solubilities (>3 M at room temperature) in water, this strategy affords a potential pathway for high-throughput separation of CO₂ from air or flue gas. Additionally, the fact that the entire process takes place in the liquid phase offers a potentially simpler and lower-cost CCS route as compared to schemes in which having absorbed CO₂ using alkaline solution, precipitation and heating of solid carbonates is required to release gaseous CO₂.[7, 8, 17]

We envision a thermodynamic cycle that includes a series of alternating electrochemical and gas-liquid exchange processes: (1) electrochemical acidification of an electrolyte at constant DIC concentration, resulting in supersaturation of aqueous CO₂; (2) outgassing of pure CO₂ gas at the collection stream until gas-liquid equilibrium is reached; (3) electrochemical de-acidification of the electrolyte, resulting in strongly alkaline electrolyte; and (4) invasion of CO₂ from air/flue gas into the alkaline electrolyte. During each process, the constituents of DIC and pH can be described based on CO₂-carbonate and water dissociation equilibria, as well as the principle of charge conservation. Based on the definition of DIC set forth in equation 1, the concentration of each component of DIC as a function of total DIC and [H⁺] is given by [15]

$$\begin{matrix}[ {CO}_{2} ( aq ) ] = \frac{DIC}{1 + \frac{{K}_{1}}{[ {H}^{+} ]} + \frac{{K}_{1} {K}_{2}}{{[ {H}^{+} ]}^{2}}} ; & ( 4 ) \\ [ {HCO}_{3}^{-} ] = \frac{DIC}{1 + \frac{[ {H}^{+} ]}{{K}_{1}} + \frac{{K}_{2}}{[ {H}^{+} ]}} ; & ( 5 ) \\ [ {CO}_{3}^{2 -} ] = \frac{DIC}{1 + \frac{[ {H}^{+} ]}{{K}_{2}} + \frac{{[ {H}^{+} ]}^{2}}{{K}_{1} {K}_{2}}} . & ( 6 )\end{matrix}$$

An additional constraint is given by the water dissociation equilibrium [symbol] resulting in

[H⁺][OH⁻]=10⁻¹⁴M². (7)

Given the ionic species present, assuming the presence of an electrolyte salt that comprises cationic and anionic species S⁺ and S⁻, respectively, and imposing a charge neutrality constraint results in:

[S⁺]—[S⁻]═[OH⁻]+[HCO₃⁻]+2[C₃²⁻]—[H⁺]. (8)

The total alkalinity (TA) of the solution under consideration is defined as [15]:

TA≡[OH⁻]+[HCO₃⁻]+2[CO₃²⁻]—[H⁺]. (9)

which is numerically equal to the difference between S⁺ and S⁻ concentrations according to Eq. (8). It is important to note that PCET, involving the transfer of protons between a small molecule Q and solution, may directly change the solution TA. To understand this, consider the case of an electrochemical reduction reaction such as Q+e⁻+xH⁺↔QHₓ^{x-1} where x is the number of protons transferred per electron. To the extent that the satisfaction of charge neutrality following the reduction of Q is not fully accounted for by a change in DIC, [H⁺] or [OH⁻] content of the solution, it would result in a net increase in TA—i.e., either via a transfer of S⁻ out of the solution or a transfer of S⁺ into it. Likewise, oxidation of QHₓ^{x-1} might yield a net decrease in TA. Changes in TA cause changes in pH; we stress, however, that TA and pH are not linearly related to each other: electrochemically induced perturbations to TA affect pH only subject to equilibria represented by equations 4-8 being satisfied. In other words, PCET provides a driving force for pH swing through changing TA, but actual changes in pH depend on buffering from the CO₂-carbonate equilibrium.

Several factors dictate the practical feasibility and optimal operation of an electrochemical CO₂ separation cycle based on the schemes as described herein. With regard to a chosen redox pair Q/QH₂, high chemical stability in aqueous solution and fast redox kinetics are desirable for stable long-term operation and low activation losses. And, especially for CCS schemes in which oxygen composes a large fraction of the inlet gas composition (as in DAC), a high redox potential would be necessary to reduce or even eliminate the thermodynamic susceptibility of QH₂ to reversible chemical oxidation by O₂, which would cause an efficiency loss and possibly a cell electrolyte imbalance as well.

The most important attribute of Q, however, has to do with the highest pH it can effect upon being reduced during electrochemical de-acidification, as this determines the maximum value of DIC that can be deployed in a full CCS cycle and thus, the maximum CO₂ separation throughput per cycle. Higher values of DIC entail higher outgassing overpressures, which will require higher pH values to be achieved after electrochemical de-acidification. In the ideal cycle under consideration, the hypothetical redox pair is considered capable of concerted 2H⁺, 2e⁻ PCET at all pH values, however in real aqueous solutions, PCET would be strongly affected by the affinity of the reduced reactant for protons. A common measure of this proton affinity is the pKₐ of the protonated form of the reduced reactant, which is calculated based on the equilibrium between its protonated and deprotonated variants. A simplified reaction equation representing this equilibrium is:

QH₂↔Q²⁻+2H⁺

Here, the equilibrium constant for this reaction is

$${K}_{a} = \frac{{[ {Q}^{2 -} ] [ {H}^{+} ]}^{2}}{[ {QH}_{2} ]} ;$$

and the pKₐ is defined as the logarithmic constant, −log₁₀ Kₐ. As this equilibrium is highly sensitive to solution acidity, increasingly basic solutions will favor the formation of the deprotonated Q²⁻ rather than QH₂, in which case reduction of Q will not result in solution de-acidification as assumed. Based on the pKₐ values and the water dissociation equilibrium, as well as the conservation of the total concentration of the molecule in all redox states, the ideal relationship between pKₐ, Q concentration (i.e., the concentration of the oxidized form of the molecule) and final pH was derived as described herein. As expected, the final pH scales strongly with pKₐ, but is limited at low Q/QH₂ solubilities. As an illustration, consider a solution of Q with pKₐ 15—at a concentration of 50 mM, it will reach only pH 13 (equivalent to 100 mM OH⁻) upon bulk electrolytic reduction, but will achieve a pH of 14.7 for a Q concentration of 4.0 M. Finding redox-active species with a combination of high solubility and high pKₐ is therefore critical for reaching high DIC values in the electrochemical cycle, and thereby enabling high-throughput CO₂ separation. Although DIC values greater than 3 M can, in principle, be attained in aqueous solution (room-temperature solubilities for NaHC₃, Na₂CO₃, KHCO₃ and K₂CO₃ are 11.4, 3.2, 3.3 and 8.1 M, respectively), solubilities of molecules capable of undergoing PCET across a wide pH range are typically lower, and thus limit DIC values that can be utilized in an electrochemical CCS cycle.

There has been extensive research into organic molecules capable of PCET, in part because it is pivotal in many biological energy-conversion processes such as respiration and photosynthesis.[18] In the field of aqueous organic redox-flow batteries (RFBs) in particular, it has been shown that several quinone-based molecules can undergo 2H⁺, 2e⁻ PCET with fast kinetics. One major drawback, however, is that these molecules typically have pKₐ's that are <11.0, and solubilities <1.0 M [11, 19-21] 1,2-benzoquinone-3,5-disulfonic acid is a rare exception in the latter category, with a reported solubility of 3.0 M, however its chemical instability in water [22] renders it unattractive for electrochemical CO₂ separation. Aza-aromatic redox-active compounds are potentially more promising in terms of both high solubility and pKₐ. Although it does not participate in PCET for most of the 0-14 pH range, quinoxaline has been shown to have a solubility above 4.0 M in water and in weakly alkaline aqueous solution.[23] Phenazine, however, participates in 2H⁺, 2e⁻ PCET up to at least pH 13 [24]. Among organic molecules that can undergo PCET for RFBs, phenazine dihydroxysulfonic acid has the highest solubility yet reported (1.8 M), and it is reasonably chemically stable (i.e., decomposing at <1%/day). [25] Besides organic molecules, polyoxometalates have attracted interest as potentially highly soluble candidates for reactants in RFBs [26, 27] and redox mediators for water splitting/reduction [27, 28]. Although they tend to be insoluble and redox-inactive in basic solution [29], they are, in principle, capable of greater than 2 H⁺, 2e⁻ PCET. Chen et al.[27] demonstrated that a tungsten-based polyoxoanion can stably undergo an 18 H⁺, 18 e⁻ redox process at a concentration of 0.5 M, with the potential to go up to 2.0 M, although its behavior in basic solution was not reported. The development of a similar reactant capable of PCET across the pH 3-13 range would effect a much larger pH swing per mole of reactant than heretofore assumed, thus lowering the required reactant solubility. Indeed, continued exploration of the large parameter space to which inorganic and organic redox-active species belong may yield candidates for electrochemical CO₂ separation that boast higher solubility and pKₐ than those assumed here, and applying insights from the fields of electrocatalysis and energy storage may prove beneficial toward that goal.

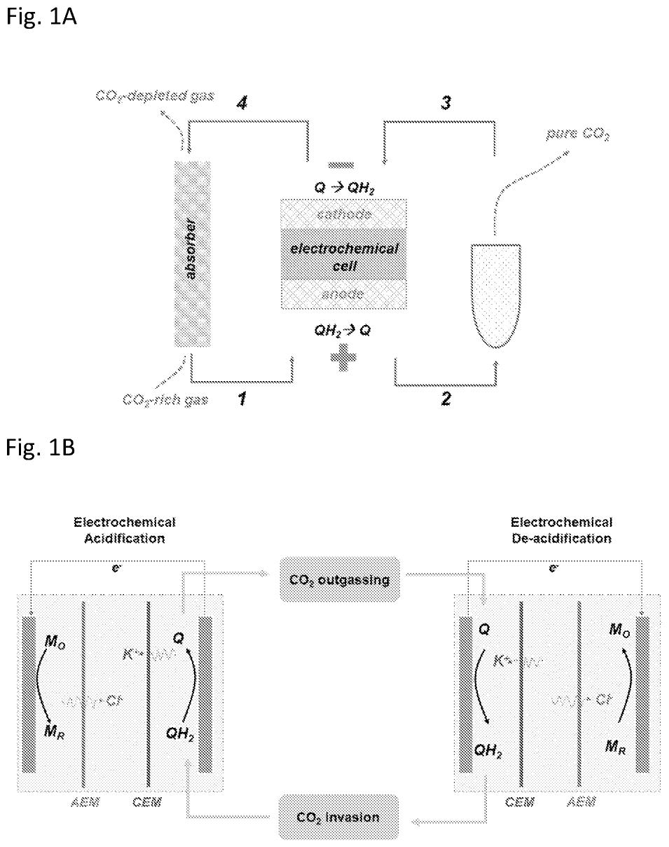

Another critical question bearing on the practical implementation of this scheme relates to the nature of the electrochemical cell, and how it is integrated with CO₂ capture and release. In FIGS. 1A-1B, it is assumed that these processes occur in steady-state: the electrolyte flows between an air contactor [17, 30] at the inlet, where CO₂ absorption occurs at high pH; an electrochemical cell where acidification/de-acidification take place; and the exit, where CO₂ is released at low pH. In order to maintain this pH gradient across the electrodes of the cell, it would be critical to have an ion-selective membrane that would strongly suppress the permeation of any ions that affect the solution TA (i.e., ions on the right hand side of equation 9). An anion-exchange membrane (AEM) with high perm-selectivity for Cl⁻ ions would be particularly ideal for this purpose, but a high concentration of Cl⁻ would be needed in practice to limit the amount of crossover of hydroxide, which has a higher mobility than Cl⁻.[31] An alternative strategy is to set up an electrochemical cell with the electrodes separated by both a cation-exchange membrane (CEM) as well as an AEM, to block the crossover of anionic proton acceptors and H⁺, respectively. The use of two membranes would require CO₂ absorption and release to be time-separated processes occurring after de-acidification and acidification, respectively, as illustrated in FIG. 1B. This configuration allows the electrochemical cell to be integrated within an aqueous flow battery architecture for simultaneous CCS and energy storage/conversion. A similar concept has recently been demonstrated for electrochemical water desalination by Desai et al.[32] Maximizing the overall energy efficiency of the system would require minimizing charge transport losses by using thin membranes with high perm-selectivity, minimizing activation losses by using catalytically active high-surface-area electrodes and redox-active species with fast kinetics, and minimizing mass transport/fluid pumping losses by using carefully engineered electrode pore structures [33, 34] and flow fields.[35-39]

The use of redox-active species and cell architectures that impose minimal kinetic losses while preserving the pH gradient would be crucial to realizing electrochemical CCS at low energetic cost. Watkins et al.[40] have demonstrated CO₂ separation from flue gas using a pH gradient created by Pt-catalyzed PCET reactions using benzoquinone and 2,6-dimethylbenzoquinone, however the kinetic sluggishness of the associated redox reactions and the absence of an ion-selective membrane in their design result in a practical energy input of 600 kJ/mol_{CO2}. In contrast, we envision the ideal cycle detailed in this work operating with an ion-selective membrane, and able to make use of any redox-active species within a wide array of reactants capable of PCET. In the organic RFB literature, several organic molecules have been shown to have kinetic rate constants on the order of 10⁻³ cm/s or above on inexpensive carbon electrodes[9, 19, 41, 42], demonstrating the wide availability of reactants for CO₂ separation that will impose minimal energetic losses in an electrochemical cell.[41]

In addition to minimal energetic losses, another important criterion for wide scale adoption of CO₂ separation technology is the use of low-cost cell components and working fluids. The process described here can, in principle, use water-soluble molecules and aqueous electrolytes. This is in contrast to most of the electrochemical CO₂ separation methods that do not feature the use of a pH swing which have been described in the literature, involving direct binding of CO₂ to reduced quinones [43, 44] and oxygen-assisted conversion of CO₂ to oxalate species[45]—all of which require more expensive organic solvents to operate. As previously discussed, EMAR has been experimentally demonstrated to require an exceptionally low electrical energy input of 100 kJ/mol_{CO2}, which is comparable to what may be expected of our process assuming similar second-law efficiencies.

When a voltage is applied to an aqueous solution or aqueous suspension containing a proton-coupled redox active species, e.g., a hydroquinone, a hydrophenazine, or others, the proton-coupled redox active species is reversibly oxidized, releasing one or more protons or electrons. The protons released reduce the pH of the aqueous solution or aqueous suspension, resulting in the release of CO₂ from the aqueous solution. Reducing the proton-coupled redox active species after releasing CO₂ then increases the pH of the aqueous solution or aqueous suspension by removing protons, thereby allowing absorption of more CO₂ at higher pH.

An advantage of this invention is the reduced energy input required to capture CO₂. In general, all methods of capturing CO₂ require some level of energy input, e.g., thermal, electrical, or both. Most currently available methods require anywhere from −100 to 600 kJ/mol_{CO2} to capture CO₂ because of losses from metal catalyst interactions (e.g., binding), water splitting reactions, and/or other endothermic processes, such as material regeneration. In contrast, CO₂ capture devices of the current invention eliminate the need for thermal energy input and reduce the electrical energy input required to potentially between 15-70 kJ/mol_{CO2} (e.g., 30-70 kJ/mol_{CO2}), about 30% less energy intensive than competing technologies. The present invention also does not require water splitting or metal catalysts for operation.

### CO₂ Capture Devices

The CO₂ capture device of the invention is based on the use of a proton-coupled redox active species, e.g., a hydrophenazine/phenazine couple, hydroquinone/quinone couple, or other redox-active couple. FIGS. 1A-1B provide basic schemes of devices incorporating a single electrochemical cell (FIG. 1A) or a pair of electrochemical cells (FIG. 1B) configured to capture and then release CO₂, e.g., from either flue gas or air. In one embodiment, the capture devices of the invention include a liquid flow path that includes four regions for capture and release of CO₂. In the first region, gas containing CO₂ contacts an aqueous solution or suspension containing the proton-coupled redox active species at a high pH. This region also includes a gas outlet to allow the carrier source gas, e.g., flue gas or air, to exit the device after being depleted of CO₂. The second region includes at least one electrode. Here, the proton-coupled redox active species is reversibly oxidized to release one or more protons and electrons, thereby reducing the pH of the aqueous solution or suspension. The third region includes a gas outlet to collect CO₂ after it outgasses from the aqueous solution or suspension. The outlet may be collected to a storage container for CO₂. The third region may also include an inlet for the addition of a carrier gas to assist in removing CO₂ from the device. The fourth region also includes at least one electrode. Here, the proton-coupled redox active species is reduced, removing one or more protons and electrons from the aqueous solution or suspension, thereby increasing the pH to allow for capture of additional CO₂. In certain embodiments, the second and fourth regions are separated by an ion-conducting barrier, e.g., an anion exchange membrane or cation exchange membrane, allowing charge to flow between the two regions.

In certain embodiments, the device can be configured to capture and release CO₂ in a continuous manner. In this embodiment, the aqueous solution or suspension is circulated continuously through the four regions. Thus, CO₂ dissolves in the aqueous solution or suspension in the first second, the pH decreases in the second region, CO₂ outgasses in the third region, and the pH increase in the fourth region all at the same time, while the aqueous solution flows through the regions. Alternatively, the device can be configured to capture and release CO₂ in a sequential manner, e.g., performing the steps of each region individually. For example, the aqueous solution or suspension may be allowed to absorb CO₂ in the first region, e.g., to saturation; the solution or suspension is then transferred to the second region where the pH is reduced; the solution or suspension is then transferred to the third region where CO₂ outgasses; and the solution or suspension is then transferred to the fourth region where the pH decreases.

In some cases, a device of the invention includes two or more electrochemical cells, with each cell having its electrodes separated by both a cation-exchange membrane (CEM) and an anion exchange membrane (AEM). A schematic of this setup is shown in FIG. 1B. In this configuration, the use of both a CEM and an AEM in each electrochemical cell blocks the crossover of anionic proton acceptors and H⁺, respectively. This device configuration allows the electrochemical cell to be integrated within an aqueous flow battery architecture for simultaneous CCS and energy storage/conversion. For devices such as that depicted in FIG. 1B, each electrochemical cell is configured to include additional redox processes occurring counter to the redox processes of the redox-active couple that drives the capture and release of CO₂ in the device. The counter redox processes may be symmetric with respect to the redox-active couple that drives the capture and release of CO₂ in the device, e.g., if the redox process driving CO₂ capture and release is Q/QH₂, then the counter process is QH₂/Q. Alternatively, the counter redox processes may be asymmetric with respect to the redox-active couple that drives the capture and release of CO₂ in the device. The counter redox active species may be any suitable species, such as bromine, chlorine, iodine, oxygen, vanadium, chromium, cobalt, iron, e.g., ferricyanide/ferrocyanide, aluminum, e.g., aluminum(III) biscitrate monocatecholate, manganese, cobalt, nickel, copper, or lead, e.g., a manganese oxide, a cobalt oxide, or a lead oxide.

In other embodiments, a device of the system may include fewer regions. For example, a device of the invention may include a fluid reservoir containing an aqueous solution or aqueous suspension of the proton-coupled redox active species, and electrode, and an inlet and outlet for gas introduction. In this embodiment, the steps of CO₂ capture, acidification, release, and deacidification all occur in the reservoir in sequence. In other embodiments, the device includes two or three regions, e.g., where CO₂ capture and acidification occur in the same region, with release occurring in the same region or a separate region and deacidification occurring in another region.

During invasion, the high-pH liquid may be sprayed down through a solid lattice, providing a liquid/gas interface for CO₂ in the gas to enter the liquid. A similar lattice may be employed when CO₂ gas is released from the liquid.

### Electrode Materials

Electrodes for use with devices of the invention include any carbon electrode, e.g., glassy carbon electrodes, carbon paper electrodes, carbon felt electrodes, or carbon nanotube electrodes. Titanium electrodes may also be employed. Electrodes can also be made of a high specific surface area conducting material, such as a nanoporous metal sponge (T. Wada, A. D. Setyawan, K. Yubuta, and H. Kato, Scripta Materialia 65, 532 (2011)), which has been synthesized previously by electrochemical dealloying (J. D. Erlebacher, M. J. Aziz, A. Karma, N. Dmitrov, and K. Sieradzki, Nature 410, 450 (2001)), or a conducting metal oxide, which has been synthesized by wet chemical methods (B. T. Huskinson, J. S. Rugolo, S. K. Mondal, and M. J. Aziz, arXiv:1206.2883 [cond-mat.mtrl-sci]; Energy & Environmental Science 5, 8690 (2012); S. K. Mondal, J. S. Rugolo, and M. J. Aziz, Mater. Res. Soc. Symp. Proc. 1311, GG10.9 (2010)). Chemical vapor deposition can be used for conformal coatings of complex 3D electrode geometries by ultra-thin electrocatalyst or protective films. Other electrodes are known in the art.

### Ion Conducting Barriers

The ion conducting barrier allows the passage of ions from an aqueous solution, but preferably not a significant amount of the proton-coupled redox active species. In particular, an anionic exchange membrane can be used, e.g., to allow chloride ions to pass. Anion specific conducting barriers are typically ionomers, e.g., ion-conducting polymers, including, but not limited to aromatics, e.g., xylylenes, polysulfones, e.g., polyethersulfone, and amine functionalized fluoropolymers, e.g., FUMASEP®. Examples of membranes include Selemion DSV and Selemion AMV. Other anion-specific ion conducting barriers are known in the art.

### Proton-Coupled Redox Active Species

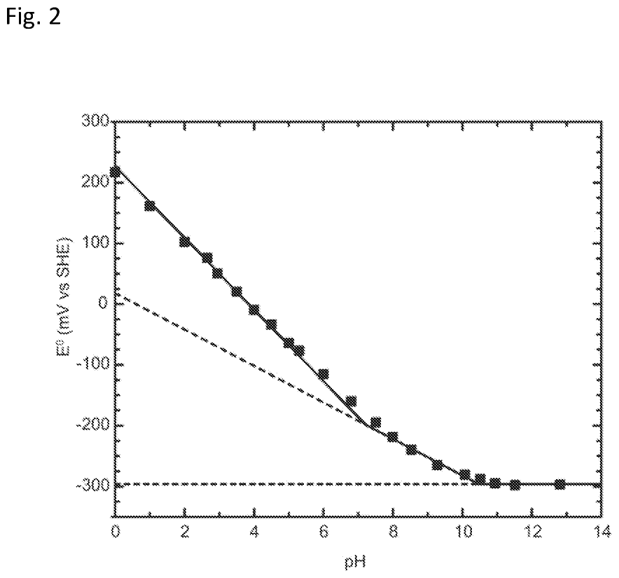

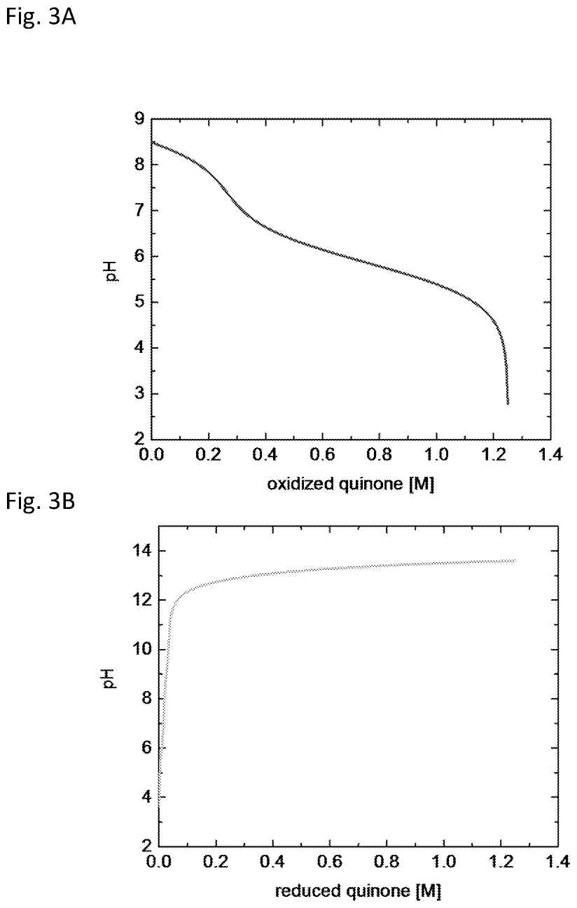

Exemplary proton-coupled redox active species for use in the invention are quinones, phenazines, alloxazines, isoalloxazines, polyoxometalates, and their reduced counterparts. The ability of phenazines and quinones to both accept and release a proton at modest electrical potentials makes them ideal candidates for creating pH “swings” in an aqueous solution. FIG. 2 shows the reduction potential of a quinone, suggesting that the PCET mechanism, across a fairly wide pH range, can change the activity of protons in aqueous solutions or aqueous suspensions to control the solubility of CO₂ in aqueous solution or suspension (see also, ref. [46] for the reduction potential of phenazine). FIGS. 3A and 3B show the pH dependence of the concentrations of quinone (FIG. 3A) and hydroquinone (FIG. 3B), indicating that at a lower pH, the quinone is nearly all in its oxidized form. The pH-dependence of the redox potentials of the quinone species (shown in FIGS. 2, 3A and 3B) can be used with the Nernst equation to estimate the amount of electrical energy, e.g., work, required to drive the CO₂ capture and release cycle. In certain embodiments, the proton-coupled redox active species has a pKₐ of at least 7, at least 8, at least 9, at least 10, at least 11, at least 12, at least 13 or at least 14.

Quinones include benzoquinones, naphthoquinones, and anthraquinones. Examples of quinones useful in the capture device of the invention include those of formulas (A)-(D):

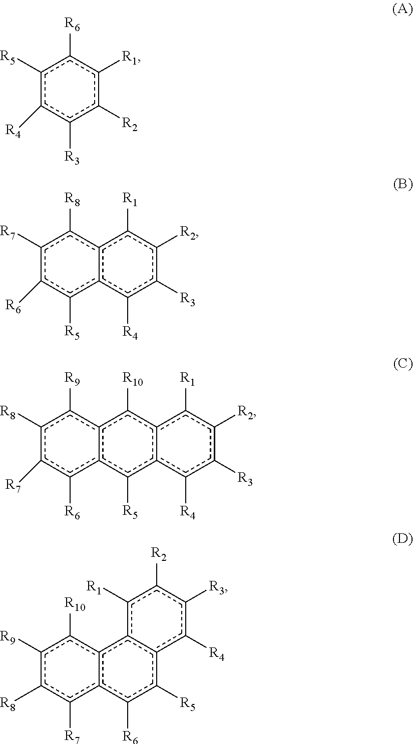

wherein each of R₁-R₁₀ is independently selected from H, optionally substituted C₁₋₁₀ alkyl (e.g., C₁₋₆ alkyl), halo, hydroxy, —CN; —NO₂; —ORₐ; —SRₐ; —N(Rₐ)₂; —C(═O)Rₐ; —C(═O)ORₐ; —S(═O)₂Rₐ; —S(═O)₂ORₐ; —P(═O)Rₐ₂; —O—P(═O)(ORₐ)₂, —P(═O)(ORₐ)₂, and oxo, wherein each Rₐ is independently H, optionally substituted C₁₋₁₀ alkyl (e.g., C₁₋₆ alkyl); optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group, or an ion thereof, provided that two of R₁-R₆ for formula (A) are oxo, two or four of R₁-R₈ for formula (B) are oxo, and two, four, or six of R₁-R₁₀ for formulas (C) and (D) are oxo, wherein the dashed lines indicate that the monocyclic ring of formula (A), the bicyclic ring of formula (B), and the tricyclic rings of formulas (C) and (D) are fully conjugated. Typically, at least one of the R groups that is not oxo for each of formulas (A)-(D) is not H. In certain embodiments, none of the R groups for formulas (A)-(D) are H. In preferred embodiments, at least two R groups of formulas (A)-(D) are oxo, which are separated by an even number of carbons. Other formulas are (I), (II), and (III):

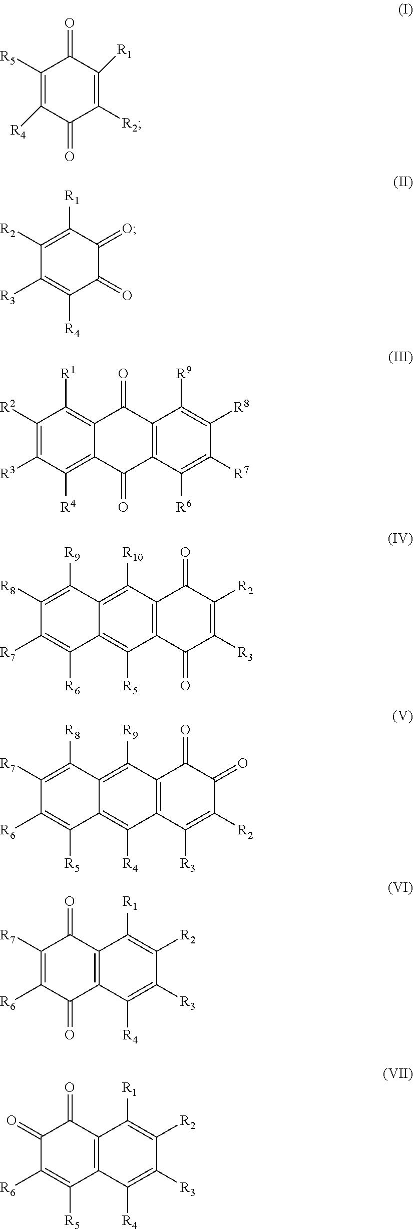

Table 1 below presents possible substitutions for the quinone of formula (III), also contemplating ions and reduced species thereof.

TABLE 1
Possible substituents for a quinone of Formula (III).

| | |
|---|---|
| | (I) |
| 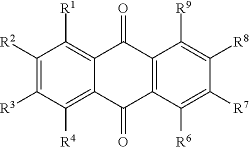 | |

| —R | | | | | | | | |
|---|---|---|---|---|---|---|---|---|
| substituted | R₁ | R₂ | R₃ | R₄ | R₆ | R₇ | R₈ | R₉ |
| | H | OH | H | H | H | H | H | H |
| | H | SO₃H | H | H | H | H | H | H |
| Di- | OH | OH | H | H | H | H | H | H |
| | OH | H | OH | H | H | H | H | H |
| | OH | H | H | OH | H | H | H | H |
| | OH | H | H | H | OH | H | H | H |
| | OH | H | H | H | H | H | OH | H |
| | OH | H | H | H | H | H | H | OH |
| | H | OH | H | H | H | OH | H | H |
| | H | OH | H | H | H | H | OH | H |
| | H | SO₃H | H | H | H | H | SO₃H | H |
| Tri- | OH | OH | OH | H | H | H | H | H |
| | OH | OH | H | OH | H | H | H | H |
| | OH | OH | H | H | H | OH | H | H |
| | OH | OH | H | H | H | H | OH | H |
| | OH | H | OH | H | H | H | H | OH |
| | OH | OH | SO₃H | H | H | H | H | H |
| | OH | SO₃H | H | OH | H | H | H | H |
| Tetra- | OH | OH | OH | OH | H | H | H | H |
| | OH | OH | H | H | OH | OH | H | H |
| | OH | OH | H | H | OH | H | H | OH |
| | OH | H | H | OH | OH | H | H | OH |
| | H | OH | OH | H | H | OH | OH | H |
| | OH | SO₃H | OH | OH | H | H | H | H |
| | OH | SO₃H | H | OH | H | SO₃H | H | H |
| | OH | SO₃H | H | OH | H | H | SO₃H | H |
| | OH | SO₃H | H | H | H | H | OH | SO₃H |
| Penta- | OH | SO₃H | OH | OH | H | SO₃H | H | H |
| | OH | SO₃H | OH | OH | H | H | SO₃H | H |

In other embodiments of Formula III, the quinone is substituted, i.e., not H, only at R² and R⁸, R² and R⁹, R² and R⁷, R² and R⁶, R¹ and R⁹, R¹ and R⁸, R¹ and R⁷, or R¹ and R⁶. Yet further quinones are those of Formula (III), where R² and R⁸ are SO₃H, no, one, two, three, four, five, or six of the remaining R groups are OH.

Additional quinones include 9,10-anthraquinone-2,7-disulfonic acid, 9,10-anthraquinone-2,6-disulfonic acid, 9,10-anthraquinone-1,8-disulfonic acid, 9,10-anthraquinone-1,5-disulfonic acid, 9,10-anthraquinone-2-sulfonic acid, 9,10-anthraquinone-2,3-dimethanesulfonic acid, 1,8-dihydroxy-9,10-anthraquinone-2,7-disulfonic acid, 1,5-dihydroxy-9,10-anthraquinone-2,6-disulfonic acid, 1,4-dihydroxy-9,10-anthraquinone-2-sulfonic acid, 1,3,4-trihydroxy-9,10-anthraquinone-2-sulfonic acid, 1,2-naphthoquinone-4-sulfonic acid, 1,4-naphthoquinone-2-sulfonic acid, 2-chloro-1,4-naphthoquinone-3-sulfonic acid, 2-bromo-1,4-naphthoquinone-3-sulfonic acid, 2,6-dihydroxy-9,10-anthraquinone (2,6-DHAQ), 1,5-dimethyl-2,6-dihydroxy-9,10-anthraquinone, 2,3,6,7-tetrahydroxy-9,10-anthraquinone, 1,3,5,7-tetrahydroxy-2,4,6,8-tetramethyl-9,10-anthraquinone, and 2,7-dihydroxy-1,8-dimethyl-9,10-anthraquinone. Particularly preferred quinones for use in this invention include 2,6-DMAQ, 1,5-dimethyl-2,6-dihydroxy-9,10-anthraquinone, 2,3,6,7-tetrahydroxy-9,10-anthraquinone, 1,3,5,7-tetrahydroxy-2,4,6,8-tetramethyl-9,10-anthraquinone, and 2,7-dihydroxy-1,8-dimethyl-9,10-anthraquinone. A further specific example is 3,4-dihydroxy-9,10-dioxo-2-anthracenesulfonic acid or an ion thereof.

Other quinones, which have multiple oxidation states, include:

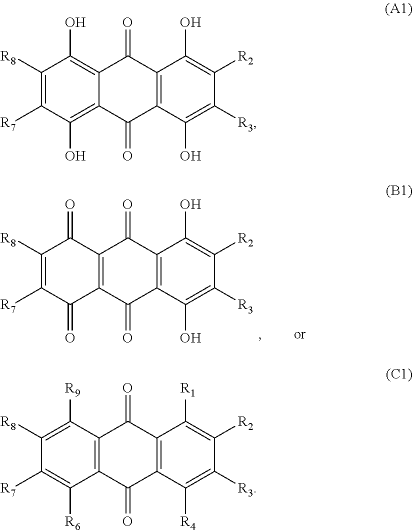

The double bonds within the rings represent full conjugation of the ring system. It will be understood that when one or more of R₁-R₈ is oxo, the number of the double bonds within the ring will be reduced, and the depicted double bond location may change.

Table 2 presents specific hydroxyquinones useful as proton-coupled redox active species. The numbering for Table 2 is as follows:

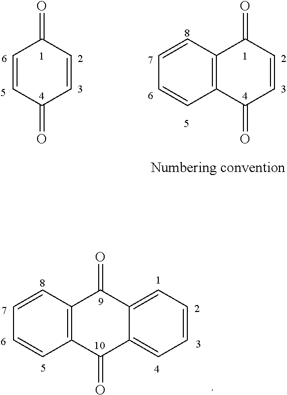 [SMILES: O=C1C=CC(=O)C=C1 ; O=C1C=CC(=O)c2ccccc21 ; O=C1c2ccccc2C(=O)c2ccccc21]

TABLE 2

| | | R-group | Position of substituted |
|---|---|---|---|
| ID | Class | substituted | R-group |
| 1 | 9,10-AQ | OH | Full |
| 2 | 1,5-AQ | OH | Full |
| 3 | 1,10-AQ | OH | Full |
| 4 | 1,4-AQ | OH | Full |
| 5 | 2,3-AQ | OH | Full |
| 6 | 9,10-AQ | NH₂ | Full |
| 7 | 1,4-AQ | NH₂ | Full |
| 8 | 1,10-AQ | NH₂ | Full |
| 9 | 2,9-AQ | NH₂ | Full |
| 10 | 1,5-AQ | NH₂ | Full |
| 11 | 2,6-AQ | NH₂ | Full |
| 12 | 1,7-AQ | NH₂ | Full |
| 13 | 2,9-AQ | OH | Full |
| 14 | 1,5-NQ | NH₂ | Full |
| 15 | 1,4-NQ | NH₂ | Full |
| 16 | 2,6-NQ | NH₂ | Full |
| 17 | 1,7-NQ | NH₂ | Full |
| 18 | 1,10-AQ | PO₃H₂ | Full |
| 19 | 1,2-AQ | OH | Full |
| 20 | 2,6-AQ | OH | Full |
| 21 | 1,7-AQ | OH | Full |
| 22 | 1,4-NQ | OH | Full |
| 23 | 1,7-NQ | OH | Full |
| 24 | 1,2-AQ | NH₂ | Full |
| 25 | 2,9-AQ | PO₃H₂ | Full |
| 26 | 1,2-NQ | OH | Full |
| 27 | 2,9-AQ | SO₃H | Full |
| 28 | 9,10-AQ | SO₃H | Full |
| 29 | 2,3-AQ | PO₃H₂ | Full |
| 30 | 1,2-NQ | NH₂ | Full |
| 31 | 9,10-AQ | COOH | Full |

or an ion thereof, wherein AQ is anthraquinone, and NQ is naphthoquinone. It will be understood that the points of substitution listed in the Class column correspond to the location of oxo groups. “Full” substitution denotes the presence of the listed R group at every ring position not having an oxo group. In other embodiments, the quinone is a 1,2-; 1,4-; 1,5-; 1,7-; 1,10-; 2,3-; 2,6-; 2,9-; or 9,10-AQ substituted with at least one of OH, NH₂, PO₃H, SO₃H, COOH, or an ion thereof. In other embodiments, the quinone is a 1,2-; 1,4-; 1,5-; 1,7-; or 2,6-NQ substituted with at least one of OH, NH₂, PO₃H, SO₃H, COOH, or an ion thereof.

Further specific quinones useful in the CO₂ capture device of the invention are in shown Table 3.

TABLE 3

| | | R-group | Position of substituted |
|---|---|---|---|
| ID | Class | substituted | R-group |
| 1 | 2,3-AQ | SO₃H | R4 |
| 2 | 1,4-BQ | PO₃H₂ | Full |
| 3 | 2,3-NQ | PO₃H₂ | R6 |
| 4 | 1,5-AQ | PO₃H₂ | Full |
| 5 | 2,3-NQ | SO₃H | Full |
| 6 | 2,3-AQ | NH₂ | R5 |
| 7 | 2,3-AQ | SH | R6 |
| 8 | 2,6-AQ | COOCH₃ | Full |
| 9 | 2,3-AQ | PO₃H₂ | R4 |
| 10 | 2,3-AQ | OH | R10 |
| 11 | 2,6-NQ | COOH | Full |
| 12 | 2,3-NQ | PO₃H₂ | R5 |
| 13 | 1,2-BQ | COOH | Full |
| 14 | 2,3-AQ | OH | R5 |
| 15 | 1,7-AQ | SO₃H | Full |
| 16 | 2,3-AQ | SO₃H | R5 |
| 17 | 2,3-AQ | PO₃H₂ | R6 |
| 18 | 2,6-AQ | COOH | Full |
| 19 | 1,5-NQ | SO₃H | Full |
| 20 | 2,3-AQ | PO₃H₂ | R5 |
| 21 | 1,7-NQ | COOH | Full |
| 22 | 1,2-BQ | PO₃H₂ | Full |
| 23 | 2,6-AQ | SO₃H | Full |
| 24 | 2,3-AQ | PO₃H₂ | R10 |
| 25 | 2,3-NQ | COOH | Full |
| 26 | 1,4-BQ | SO₃H | Full |
| 27 | 2,6-AQ | CHO | Full |
| 28 | 1,5-AQ | SO₃H | Full |

or an ion thereof, wherein BQ is benzoquinone, AQ is anthraquinone, and NQ is naphthoquinone. It will be understood that the points of substitution listed in the Class correspond to the location of oxo groups. “Full” substitution denotes the presence of the listed R group at every ring position not having an oxo group. For quinones with other than full substitution, the remaining ring positions are bound to H. In other embodiments, the quinone is a 1,2- or 1,4-BQ substituted with at least one of OH, NH₂, PO₃H, SO₃H, COOH, SH, C₁₋₁₀ alkyl ester (e.g., C₁₋₆ alkyl ester), COOH, CHO, or an ion thereof. In other embodiments, the quinone is a 1,5-; 1,7-; 2,3-; or 2,6-AQ substituted with at least one of OH, NH₂, PO₃H, SO₃H, COOH, SH, C₁₋₁₀ alkyl ester (e.g., C₁₋₆ alkyl ester), COOH, CHO, or an ion thereof. In other embodiments, the quinone is a 1,5-; 1,7-; 2,3-; or 2,6-NQ substituted with at least one of OH, NH₂, PO₃H, SO₃H, COOH, SH, C₁₋₁₀ alkyl ester (e.g., C₁₋₆ alkyl ester), COOH, CHO, or an ion thereof.

Examples of phenazines useful in the capture device of the present invention include those of the general formula:

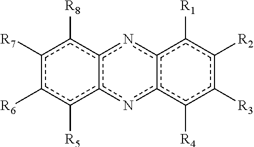

wherein each of R₁-R₈ is independently selected from H, optionally substituted C₁₋₁₀ alkyl (e.g., C₁₋₆ alkyl), halo, hydroxy, —CN; —NO₂; —ORₐ; —SRₐ; —N(Rₐ)₂; —C(═O)Rₐ; —C(═O)ORₐ; —S(═O)₂Rₐ; —S(═O)₂ORₐ; —P(═O)Rₐ₂; —O—P(═O)(ORₐ)₂, —P(═O)(ORₐ)₂, and oxo, wherein each Rₐ is independently H, optionally substituted C₁₋₁₀ alkyl (e.g., C₁₋₆ alkyl); optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group, or an ion thereof. Exemplary phenazines for use in capture devices of the present invention include 2,3-dihydroxy-phenazine-6-sulfonic acid:

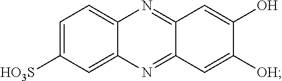 [SMILES: O=S(=O)(O)c1ccc2nc3cc(O)c(O)cc3nc2c1]

3,3′-(phenazine-2,3-diylbis(oxy))bis(propane-1-sulfonic acid) or an ion thereof:

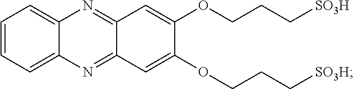 [SMILES: O=S(=O)(O)CCCOc1cc2nc3ccccc3nc2cc1OCCCS(=O)(=O)O]

and 2,3-bis(2-(2-(2-methoxyethoxy)ethoxy)ethoxy)phenazine:

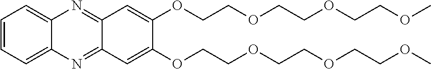 [SMILES: COCCOCCOCCOc1cc2nc3ccccc3nc2cc1OCCOCCOCCOC]

In some embodiments, the compound is an alloxazine of formula (VIII):

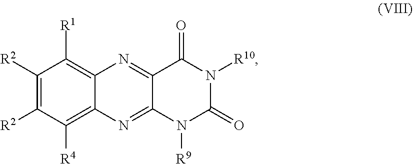

e.g., wherein each of R⁹ and R¹⁰ is independently H; optionally substituted C₁₋₁₀ alkyl (e.g., C₁₋₆ alkyl, unsubstituted C₁₋₁₀ alkyl, or unsubstituted C₁₋₆ alkyl); optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —C(═O)Rₐ; and —C(═O)ORₐ; and
each of R¹, R², R³, and R⁴ is independently H; C₁₋₁₀ alkyl (e.g., C₁₋₆ alkyl); optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —NO₂; —ORₐ; —SRₐ; —N(Rₐ)₂; —C(═O)Rₐ; —C(═O)ORₐ; —S(═O)₂Rₐ; —S(═O)₂ORₐ; —P(═O)Rₐ₂; and —P(═O)(ORₐ)₂; or any two adjacent groups selected from R¹, R², R³, and R⁴ are joined to form an optionally substituted 3-6 membered ring, or an ion thereof;
wherein each Rₐ is independently H; C₁₋₁₀ alkyl (e.g., C₁₋₆ alkyl); optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group.

In some embodiments, each of R⁹ and R¹⁰ is independently H, optionally substituted C₁₋₁₀ alkyl (e.g., C₁₋₆ alkyl), or —C(═O)ORₐ; and each of R¹, R², R³, and R⁴ is independently H, halo, optionally substituted C₁₋₁₀ alkyl (e.g., C₁₋₆ alkyl), —NO₂, —ORₐ, —SRₐ; —N(Rₐ)₂, —C(═O)ORₐ, —S(═O)₂ORₐ, —P(═O)Rₐ₂ or —P(═O)(ORₐ)₂; wherein each Rₐ is independently H or optionally substituted C₁₋₁₀ alkyl (e.g., C₁₋₆ alkyl). In some embodiments, none of, any two of, any three of, any four of, any five of, or any six of R¹, R², R³, R⁴, R⁹, and R¹⁰ are H.

In some embodiments, the compound is an isoalloxazine of formula (IX):

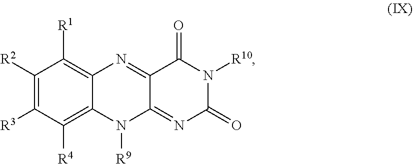

or a polymer e.g., dimer or trimer, of formula (VIII) or (IX):

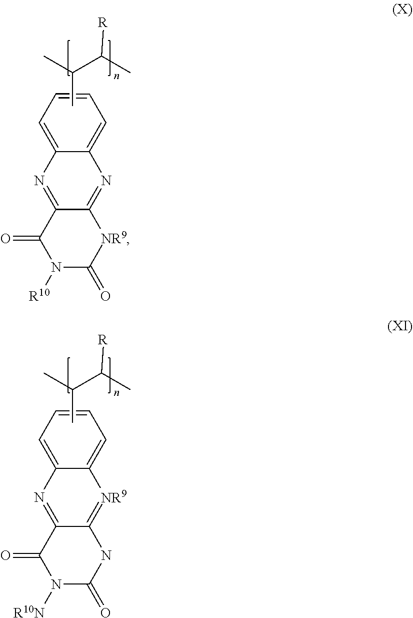

wherein n is an integer from 2 to 40; wherein R is a substituent that increase the aqueous solubility of the polymer, e.g., —OH, —COOH, —SO₃H, —N(Rₐ)₂, and —P(═O)(ORₐ)₂, where at least one Rₐ is H and other groups known in the art; and wherein other groups are as described herein. In preferred embodiments, one or both of R⁹ and R¹⁰ are H.

In some embodiments, the compound is riboflavin 5′ phosphate, having the formula:

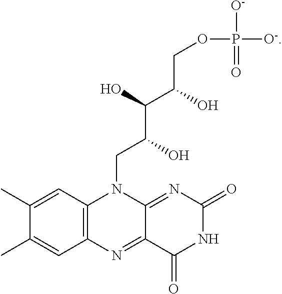

In some embodiments, the compound is alloxazine 7-carboxylic acid, alloxazine 8-carboxylic acid, 7-hydroxyalloxazine, 8-hydroxyalloxazine, 7,8-dihydroxyalloxazine, or a mixture thereof.

In some embodiments, the proton-coupled redox active species is a polyoxometalate. Exemplary polyoxometalates for use in devices of the invention include [P₂W₁₈O₆₂]⁶⁻ [27] and [SiW₁₂O₄₀]⁴⁻ [28]. Other polyoxometalates are known in the art.

The proton-coupled redox active species may or may not be present in a mixture. For example, a mixture of sulfonated quinones can be produced by reacting sulfuric acid with an anthraquinone, e.g., 9,10-anthraquinone. Proton-coupled redox active species may be dissolved or suspended in aqueous solution in the CO₂ capture device. The concentration of the redox active species ranges, for example, from 0.5 M-15 M. In addition to water, solutions may include alcohols (e.g., methyl, ethyl, or propyl) and other co-solvents to increase the solubility of a particular redox active species. In some embodiments, the solution or suspension is at least 10%, 20%, 30%, 40%, 50%, 60%, 70%, or 80% water, by mass. Alcohol or other co-solvents may be present in an amount required to result in a particular concentration of redox active species.

Exemplary substituents for a proton-coupled redox active species, e.g., a quinone, phenazine, alloxazine, or isoalloxazine, include —OH, —COOH, —PO₃H₂, —PO₃HRₐ, where Rₐ is not H; —PO₄H₂, —NRₐ₂, —SO₃H, or an ion thereof. These substituents may be directed connected to the proton-coupled redox active species or coupled via a linker such as —(CH₂)ₙ—, —O—(CH₂)ₙ—, or —S—(CH₂)ₙ—, where n=0 to 6.

### Additional Components

Devices of the invention may also include, or be configured to couple with, one or more pumps to transport liquids in the device. Suitable pumps are known in the art. The devices may also include or be configured to couple with a source of electrical energy to drive the oxidation and reduction reactions.

### Methods of Use

The invention features methods capturing CO₂, e.g., using a capture device of the invention. CO₂ can be captured and sequestered from a point source, such as the flue gas exiting a fireplace, oven, furnace, boiler or steam generator. CO₂ can also be captured and sequestered from directly from ambient air.

In the methods, CO₂ is contacted with an aqueous solution or suspension containing a proton-coupled redox active species at one pH. CO₂ dissolves into the solution or suspension and is typically converted into bicarbonate or carbonate ions. The proton-coupled redox active species is subsequently oxidized to release protons and decrease the pH, causing the dissolved bicarbonate and carbonate ions to convert to CO₂. The CO₂ is then allowed to outgas. The pH of the solution or suspension can then be increased by reducing the proton-coupled redox active species, which takes up protons. As discussed above, the process can occur continuously with the aqueous solution or suspension being circulated in a flow path or sequentially.

Invasion of CO₂ and acidification can also occur simultaneously. The simultaneous increase in the pH while adding CO₂ gas to the device will facilitate the instantaneous supersaturation of the aqueous solution or suspension, not allowing the pressure at the inlet to build up. This has two benefits to the overall cycle. The first benefit of this configuration is that the amount of lost work due to the invasion overpressure is reduced, which translates into less energy input required to separate the CO₂ gas from its source. Second, this configuration expands the choice of proton-coupled redox active species that can be used in the aqueous solution or suspension. The lower pressure going into the capture devices changes the redox potentials, which means that the proton-coupled redox active species used can be selected from a broader range of pKₐ values.

In general, the pH of the aqueous solution or an aqueous suspension will determine the solubility and form of CO₂. The pH of the aqueous solution or suspension at the time of CO₂ dissolution may be greater than or equal to 7 (e.g., at least 7, 8, 9, 10, 11, 12, 13, or 14, e.g., 7-10, 8-11, 9-12, 10-13, or 11-14). The pH of the aqueous solution or suspension at the time of CO₂ release may be less than 7 (e.g., at most 0, 1, 2, 3, 4, 5, 6, or 7, e.g., 0-5, 1-4, 0-2, 1-3, or 2-4).

In some embodiments, the increase in pH may be performed in two or more separate steps. For example, instead of increasing the pH from 3 to 14, the pH is increased from 3 to 10 and then subsequently from 10 to 14. After each step of pH increase, CO₂ invasion occurs. Increasing the pH is the most energy intensive step in the CO₂ capture cycle. Performing smaller de-acidification steps, such as going from pH 3 to pH 10, then pH 10 to pH 14, reduces the overall amount of energy needed. This may possibly allow for greater CO₂ absorption into the aqueous solution or aqueous suspension. Beyond the lower energy input required, the use of smaller pH steps has two additional benefits to the overall cycle. The first benefit is that the amount of lost work due to the invasion overpressure is reduced, which translates into less energy input required to separate the CO₂ gas from its source. Second, this expands the choice of proton-coupled redox active species that can be used as the electrolyte. Since the redox potentials of proton-coupled redox active species, e.g., quinones, are pH-dependent, the use of intermediate pH “swings” increases the number of available of proton-coupled redox active species, e.g., those having a broader range of pKₐ values.

### EXAMPLES

### Calculations of the Ideal CO₂ Capture Cycle

We have carried out a thermodynamic analysis of the energetic cost of a method of the invention, idealized as a four-step CO₂ capture cycle with a 2H⁺, 2e⁻ quinone/hydroquinone redox, involving: (1→2) acidification; (2→3) CO₂ release; (3→4) solution de-acidification; and (4→1) CO₂ invasion as described schematically in FIGS. 1A-1B. In FIGS. 1A-1B, processes 1→2 and 3→4 are constant DIC, electrochemical processes and are associated with electrical energy input/output. Processes 2→3 and 4→1 involve gas-liquid exchange of CO₂ at open circuit potential and constant TA. All processes are assumed to be isothermal.

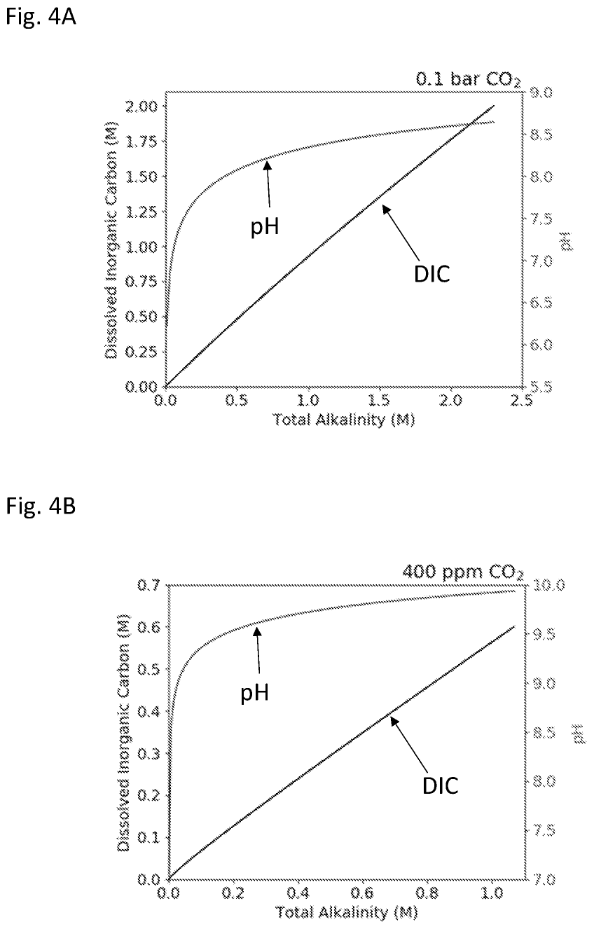

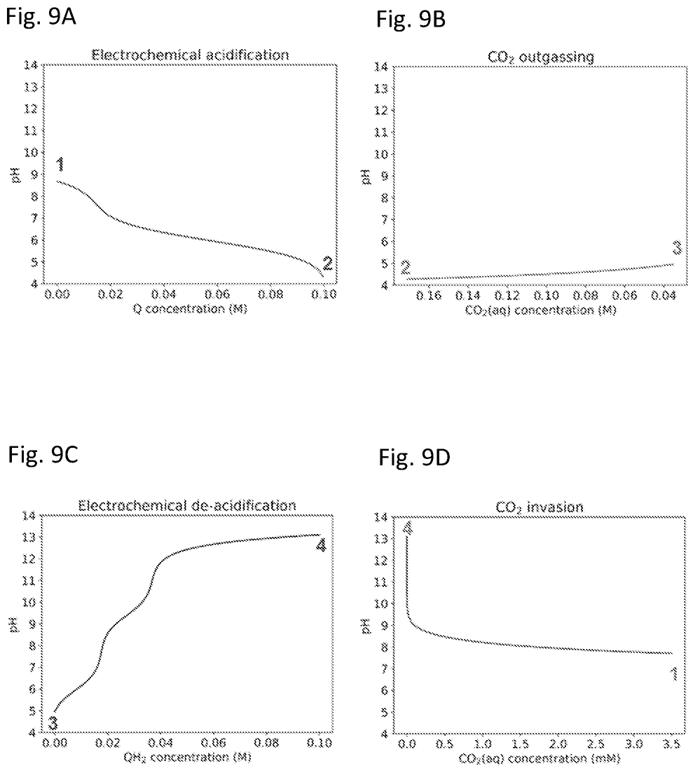

To evaluate the proposed cycle, we first performed a preliminary calculation to determine the equilibrium TA at State 1, i.e., after CO₂ invasion and before electrochemical acidification, for given values of DIC and CO₂ partial pressure. FIGS. 4A-4B shows the result of this analysis, in which solutions were found to the system of equations 4-8 for two initial CO₂ partial pressures: 0.1 bar (FIG. 4A) and 400 ppm CO₂(g) (FIG. 4B), which correspond to the CO₂ concentration of flue gas from a typical coal power plant and atmospheric CO₂, respectively. [CO₂(aq)] is assumed to be fixed based on a Henry's Law constant of 35 mM/bar at room temperature. The results show that for both conditions, TA has an almost linear relationship to DIC, with DIC=0.86×TA at 0.1 bar CO₂(g), and 0.53×TA at 400 ppm CO₂(g). Solution pH also increases with DIC, settling close to 8.6 in the limit of high DIC at 0.1 bar CO₂(g) (FIG. 4A) and 9.8 at 400 ppm CO₂ (FIG. 4B). An important reference point for these results is seawater in equilibrium with atmospheric CO₂, which mainly comprises HCO₃⁻ and is known to have a natural pH of about 8.1 for a DIC of ˜2 mM [15]. Results in FIG. 4B are consistent with this expectation, as at a DIC of 2 mM the solution pH is 8.1.

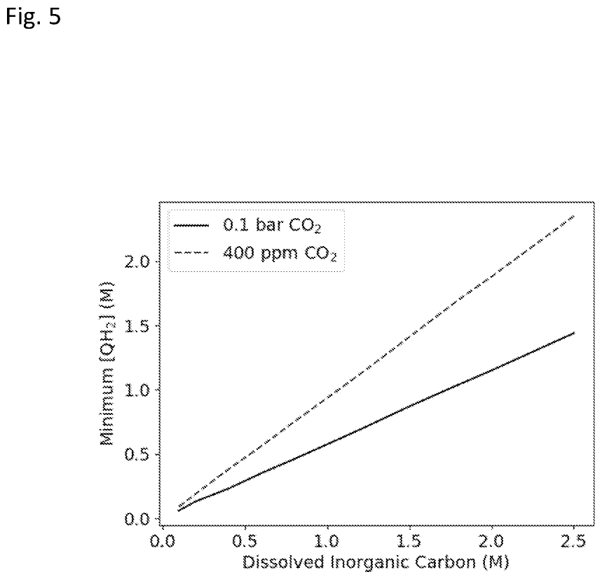

For the second step of the proposed cycle, we next calculated the minimum concentration of PCET-active molecules required for process 1-2, i.e., the electrochemical acidification of the electrolyte at a fixed DIC. FIG. 5 shows the minimum concentration of a hypothetical small molecule capable of concerted 2H⁺, 2e⁻ PCET that is required to convert all DIC to CO₂(aq). CO₂ concentrations at the CO₂— rich gas inlet of 0.1 bar and 400 ppm were considered, and the TA at State 1 was calculated based on the relationship between DIC and TA shown in FIGS. 4A-4B. Conversion of all carbonate/bicarbonate was deemed complete at the point where 99% of DIC is composed of CO₂(aq), after electrochemical acidification via QH₂ oxidation. For both inlet conditions, a linear relationship between DIC and minimum concentration of QH₂, or [QH₂]ₘᵢₙ, was obtained, with [QH₂]ₘᵢₙ equal to 0.57×DIC for the inlet with 0.1 bar CO₂, and 0.93×DIC for that with 400 ppm CO₂, for DIC values in the range between 0 and 2.5 M.

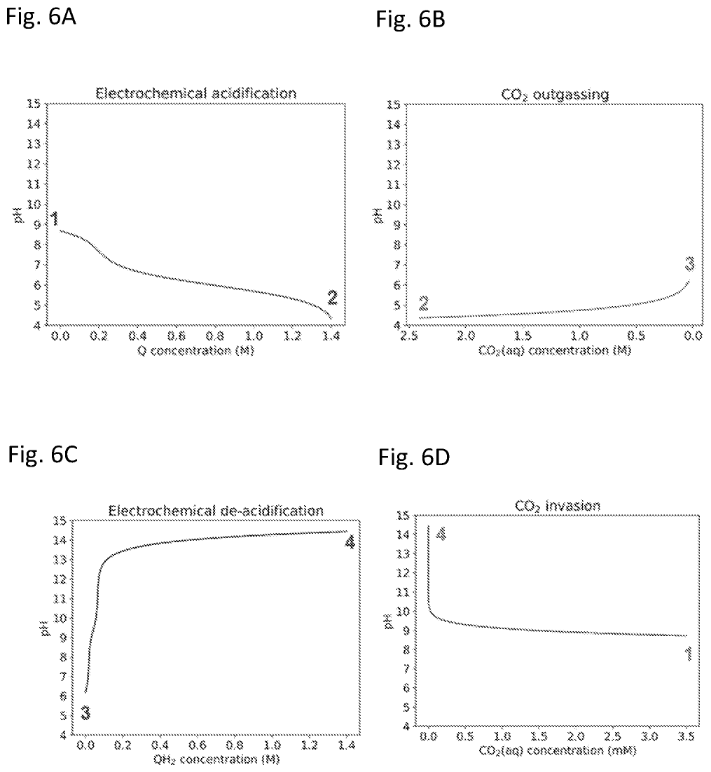

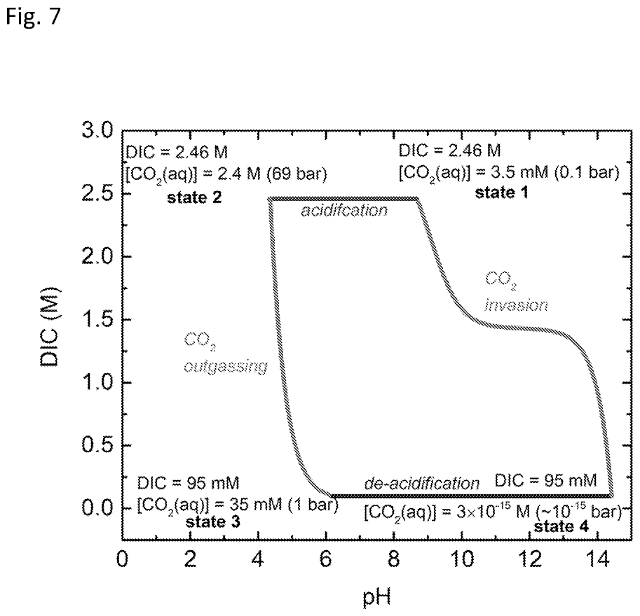

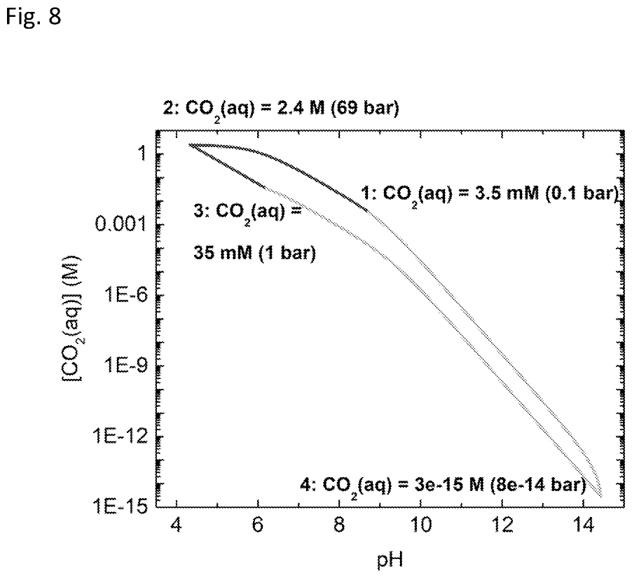

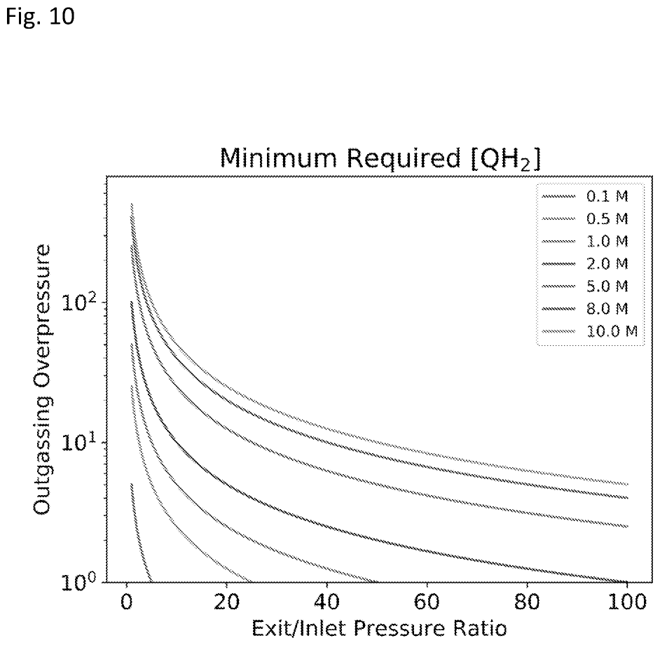

We can calculate the minimum work input required to separate CO₂ in the ideal cycle defined above. As an example of a desirable implementation, we assume an inlet CO₂ partial pressure of 0.1 bar and a starting [QH₂] of 1.4 M, which translates to a maximum convertible DIC of 2.46 M. The minimum work input is sensitive to two important parameters: the ratio of partial pressures of CO₂ at the exit to inlet stream, which we term the ‘exit/inlet pressure ratio’, and the CO₂ supersaturation at State 2, the start of outgassing. We define CO₂ supersaturation here as the ratio of [CO₂(aq)] at the start of outgassing compared to equilibrium value of [CO₂(aq)] at the exit. As the exit/inlet pressure ratio increases, the work of separation increases. CO₂ supersaturation at State 2, which we denote hereafter as ‘outgassing overpressure’, is proportional to CO₂ separation throughput as, for a given exit/inlet pressure ratio, it is a measure of how much dissolved CO₂ can be released in a single cycle. For the implementation under consideration, an exit/inlet pressure ratio of 10 was assumed (i.e., 1 bar of pure CO₂(g) at the exit stream, for 0.1 bar inlet partial pressure), resulting in an outgassing overpressure of 69. FIG. 6A shows the pH of the solution as a function of Q concentration during electrochemical acidification, going from initial pH of 8.7 to 4.3 when complete conversion is achieved. For the outgassing process 2→3 (FIG. 6B), equations 4-8 are solved subject to the constraint that TA is fixed and, that at the end of the process, [CO₂(aq)] relaxes to its equilibrium value at 1 bar of 35 mM. After this, process 3→4 (electrochemical de-acidification) is evaluated with DIC fixed at its value at State 3, using parameters from State 3 as inputs (FIG. 6C); the pH goes from 6 to ˜14.5 as the concentration of QH₂ increases. CO₂ invasion FIG. 6D) then occurs, completing the cycle and restoring State 1. The relationship between DIC and pH throughout the cycle is shown in FIG. 7, whereas that between pH and [CO₂(aq)] is shown in FIG. 8. For comparison, an ideal cycle assuming a more moderate reactant solubility (i.e., the lower of Q and QH₂ solubilities) of 0.1 M (resulting in DIC at State 1 of 0.175 M) is shown in FIG. 9A-9D. An important consequence of the lower solubility is that the pH after electrochemical de-acidification (process 3→4) is 13, rather than 14.5; this is a direct result of the lesser degree of de-acidification afforded by the removal of 0.2 M H⁺ from solution, as opposed to 2.8 M H⁺ (i.e., assuming 2H⁺,2e⁻ redox processes in both the 0.1 M and 1.4 M solubility cases). The pH attained after process 3→4 is an important metric that constrains the selection of viable molecules for electrochemical CCS. It is also important to note that based on the relationship between DIC value and minimum [QH₂] required for full acidification shown in FIG. 5, the concentration of QH₂ at State 1 constrains combinations of exit/inlet pressure ratio and outgassing overpressure that may be used in an ideal cycle. An illustration of this is given in FIG. 10, which shows lines of constant [QH₂] for different exit/inlet pressure ratios and outgassing overpressures. As expected, higher outgassing overpressures and exit/inlet pressure ratios require higher concentrations of starting [QH₂] to run a cycle.

In calculating the energetic cost/mol CO₂ separated, we note that only processes 1→2 and 3→4 involve work inputs/outputs to or from the electrochemical cell, respectively. Using the Nernst equation and assuming dilute solutions, we relate the pH during each of those processes to the redox potential (E_{R}) of the electrode at which conversion between the pairs of the Q/QH₂ redox couple occurs: E_{R}=E₀−(59 mV×pH) where E₀ is the redox potential under standard conditions, in which pH=0.

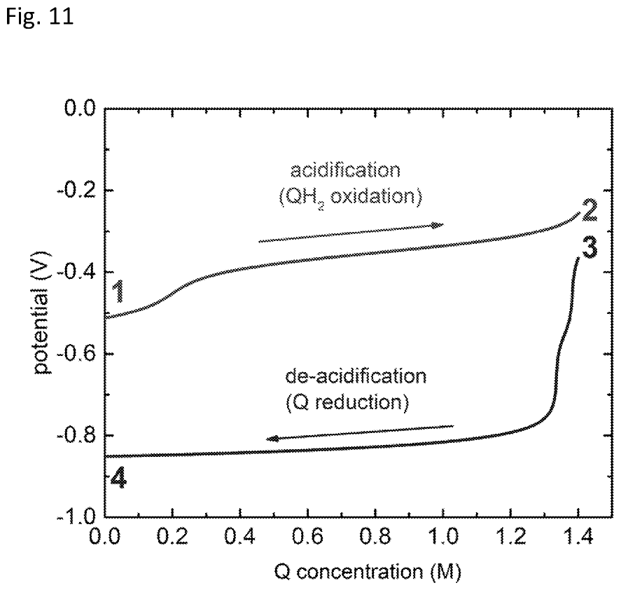

FIG. 11 shows the result of this calculation for electrochemical acidification and de-acidification, where the area between the potential profiles represents the net electrical energy input. Dividing this area by the absolute difference in [CO₂(aq)] between states 2 and 3 yields the overall work input per mole of CO₂ captured, w̅, which may be represented as follows:

$$\overline{w} = \frac{2 F}{Δ {c}_{CO 2 ( aq )}} ∮ E dq$$

Here, F is Faraday's constant of 96,485 C/mol, Δc_{CO2}(a_{q}) represents the difference in aqueous CO₂ concentration before and after CO₂ outgassing, E is redox potential, and the factor of 2 results from the assumption that each Q/QH₂ species undergoes a 2-electron redox process. In the implementation under consideration, the net electrical energy input is 50 kJ/mol_{CO2}.

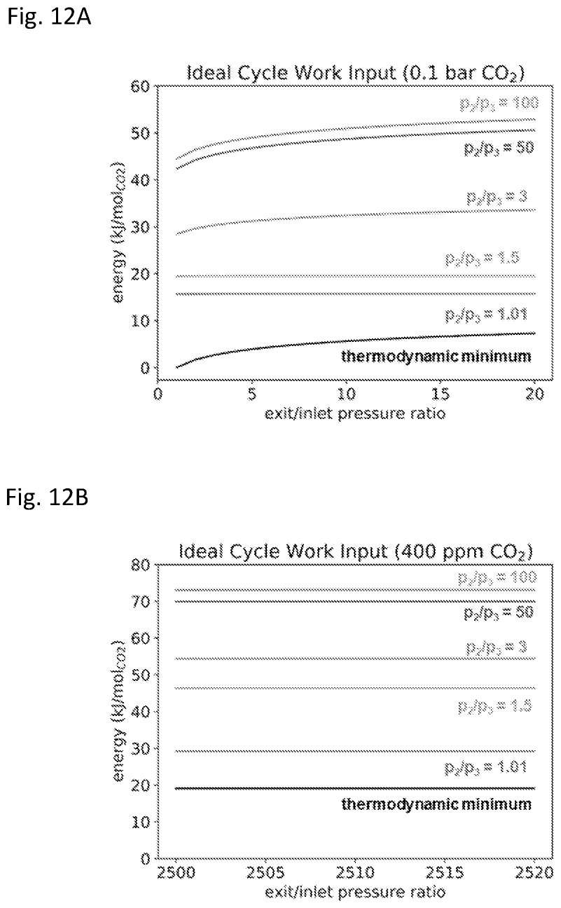

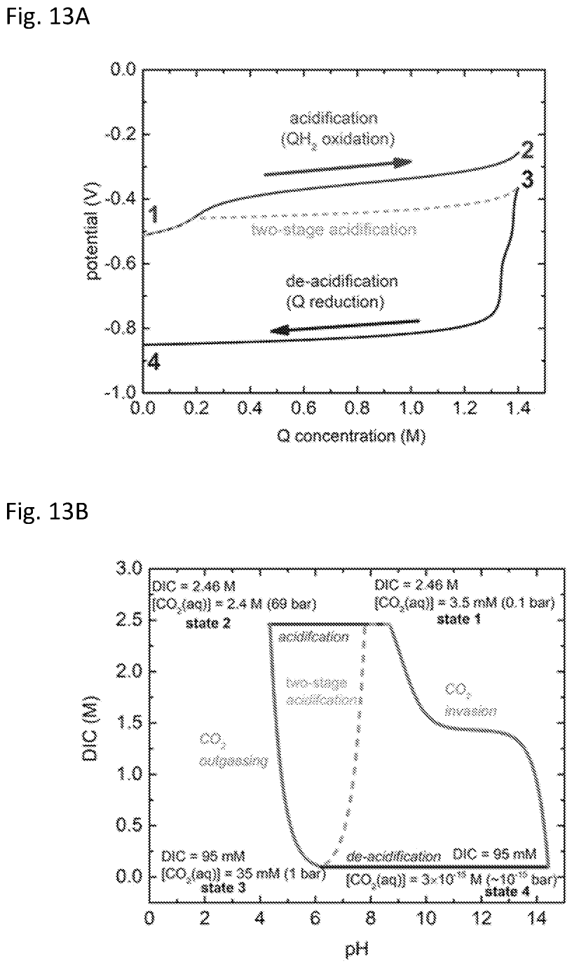

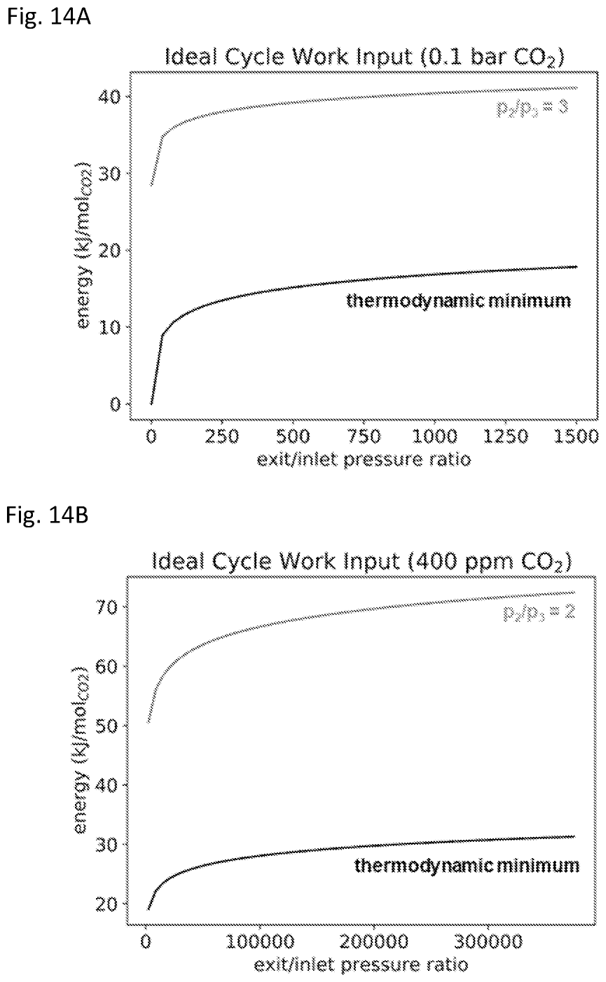

Following a program similar to that sketched out above, FIGS. 12A-12B show the ideal cycle work input required for CO₂ separation from inlet streams with 0.1 bar CO₂ (FIG. 12A) and 400 ppm CO₂ (FIG. 12B), for exit/inlet pressure ratios that result in CO₂ release around 1 bar at a variety of outgassing overpressures. Ideal cycle work is compared to the thermodynamic minimum work of separation required to provide the increase in CO₂ exergy, which, is directly related to the partial pressures of CO₂ at the inlet and exit streams[4,6]:

$$RT ln \frac{{P}_{3}}{{P}_{1}} ,$$

where R is the molar gas constant of 8.314 J/mol K and temperature Tis assumed to be 293.15 K (20° C.). For a given exit/inlet pressure ratio, the ideal cycle work input increases with outgassing overpressure, up to 50 and 75 kJ/mol_{CO2} for outgassing overpressures of 100 for inlets of 0.1 bar and 400 ppm CO₂(g), respectively. This is expected as a consequence of the fact that increasingly higher CO₂ supersaturation during the outgassing process causes increasingly greater exergetic losses in the process; these losses contribute to the difference in average pH, and thus redox potential, of the electrolyte during electrochemical acidification and de-acidification (FIG. 11). In order to reduce exergetic losses—and thus the ideal cycle work input—one might consider performing CO₂ invasion and outgassing in tandem with electrochemical acidification and de-acidification; this way, extremes in solution pH, and potential, are avoided. An exemplary application of this strategy during electrochemical acidification is presented in FIG. 13A-13B, where, for the cycle outlined in FIGS. 6A-6D, process 1→2 is broken up into two sub-processes: electrochemical acidification at constant DIC until [CO₂(aq)] is 35 mM (process 1→1a) followed by outgassing at constant [CO₂(aq)] until [Q] reaches 1.4 M (process 1a→3). As there is no outgassing, this results in a reduction in the ideal cycle work, from 50 kJ/mol_{CO2} to 42 kJ/mol_{CO2}. In practice, however, this strategy may come at the cost of lower CO₂ separation throughput, as CO₂ outgassing/invasion kinetics are faster at low/high pH, respectively.[47] It is worth noting that CO₂ separation can, in principle, be run at arbitrarily high exit/inlet pressure ratios, and thus higher exit stream CO₂ partial pressures than indicated in FIG. 12A-12B. However, as already illustrated in FIGS. 13A-13B, one would need increasingly higher concentrations of the PCET-active molecule, the solubility of which is constrained in practice. FIGS. 14A-14B illustrate such a high-pressure exit stream case, where ideal cycle work is plotted vs a series of exit/inlet pressure ratios, the highest of which yield CO₂ separation from either 0.1 bar or 400 ppm to 150 bar, i.e., approaching typical CO₂ pipeline pressures. Assuming an upper limit in QH₂ solubility of 10 M, our model predicts maximum achievable outgassing overpressures of approximately 3 and 2 for flue gas (FIG. 14A) and DAC (FIG. 14B), at work inputs of 40 and 70 kJ/mol_{CO2}, respectively.

As noted previously, we may relate solution pH to the extent of oxidized/reduced quinone for a given quinone and total concentration of Dissolved Inorganic Carbon (DIC):

[DIC]=[CO₂]+[HCO₃⁻]+[CO₃²⁻]

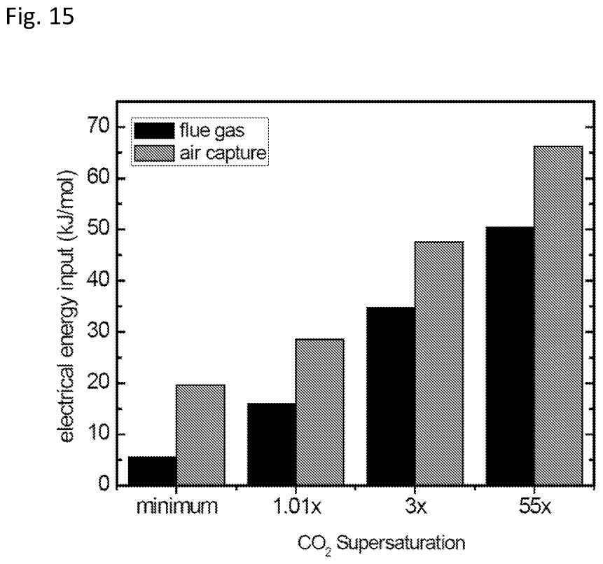

We calculated the minimum required electrical energy input for a complete CO₂ capture cycle based on the potential difference between applied reduction and oxidation potentials vs. pH using the Nernst Equation. The results of this calculation, shown in the histogram of FIG. 15, show the minimum energy input for this scheme is 30-70 kJ/mol_{CO2} depending on the degree of supersaturation for both flue gas and direct air capture, e.g., the ratio of the outgassing overpressure to the exit pressure. These energetic costs are less than or equal to the theoretical values of prior thermal and electrochemical CO₂ capture cycles. The competing electrochemical cycles cost typically about 100 kJ/mol_{CO2}, and practical implementations cost substantially more because they involve kinetically sluggish water-splitting or oxygen reduction reactions, which are not present in our PCET-mediated cycle. PCET with organic molecules that undergo kinetically rapid redox reactions [7, 8] is thus a promising candidate for CCS from flue gas or direct air capture, as it could both reduce energetic losses by a factor of two and lower overall costs/ton of CO₂ due to the low production cost of these chemicals.

Estimation of Final pH after Electrochemical De-Acidification

The relative concentration of protonated/deprotonated reduced Q is given by the Henderson-Hasselbalch equation, which relates solution pH to the pKₐ of QH₂ and the concentrations:

$$pH = {pK}_{a} + {log}_{10} \frac{[ {Q}^{2 -} ]}{[ {QH}_{2} ]} . \qquad ( 10 )$$

By assuming that each mole of QH₂ created by the bulk electrolytic reduction of a mole of Q removes 2 moles of H⁺ from solution, we can calculate the final pH of a given solution given its initial pH, the concentration of Q, and the pKₐ of Q. The final pH is given by:

pH=14−pOH, (11)

where pOH is defined based on the logarithmic constant for OH⁻ concentration, as −log₁₀[OH⁻]. Because the final pH is the sum of the initial OH⁻ concentration and OH⁻ ions created by electrochemical reduction of Q, we may re-write the above equation as:

pH=14+log₁₀(OH₀⁻+OHₙ⁻), (12)

where OH₀⁻ is the initial OH⁻ concentration and OHₙ⁻ represents newly created OH⁻. Based on the Henderson-Hasselbalch equation, one can re-express solution pH as a function of starting reactant concentration Q and its protonated reduced form, QH₂:

$${10}^{( pH - {pK}_{a} )} = \frac{[ {Q}^{2 -} ]}{[ {QH}_{2} ]} = \frac{[ Q - {QH}_{2} ]}{[ {QH}_{2} ]} = \frac{[ Q ]}{[ {QH}_{2} ]} - 1. \qquad ( 13 )$$

By re-arranging terms and assuming that the formation of each new QH₂ produces two OH⁻ ions, we obtain an expression for OHₙ⁻:

$${OH}_{n}^{-} = \frac{2 Q}{1 + {10}^{( pH - {pK}_{a} )}} . \qquad ( 14 )$$

Plugging this expression for OHₙ⁻ into the initial equation provides the full relationship between solution pH, pKₐ, initial pH and Q concentration:

$$pH = 14 + {log}_{10} ( {10}^{( {pH}_{0} - 14 )} + \frac{2 Q}{1 + {10}^{( pH - {pK}_{a} )}} ) . \qquad ( 15 )$$

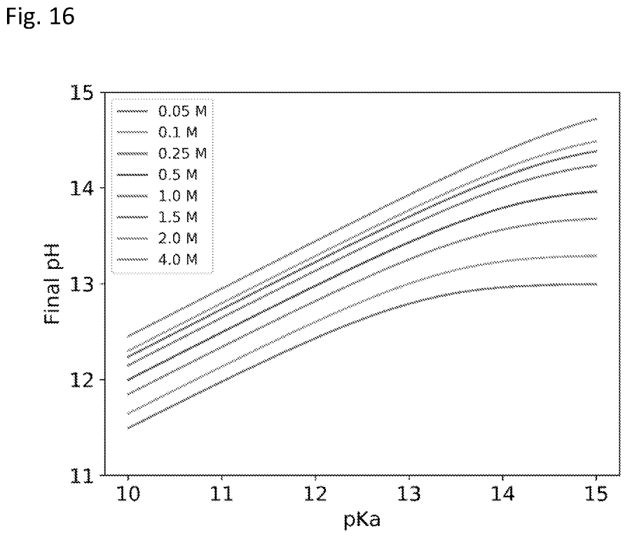

FIG. 16 depicts final pH upon full reduction of Q as a function of pKₐ for a solution with initial pH 3 and a series of Q concentrations ranging from 50 mM to 2.0 M.

It is important to note two assumptions that have been made: (1) the solution is completely unbuffered; and (2) Q has one pKₐ at which protons are in equilibrium with its deprotonated reduced form. As has been shown in the RFB literature, this is the case for some redox-active species (such as 2,6-dihydroxyanthraquinone [19]) but is not generally true for all reactants capable of PCET, which may have two distinct pKₐ values for each proton [12]. The main consequence of these assumptions is that the final pH computed above represents an upper limit, as buffering effects will reduce the power of PCET to effect pH shifts, and the presence two distinct pKₐ values imply a regime in which 2e⁻ reduction will be accompanied by removal of 1 rather than 2 protons from solution.

### REFERENCES

1. Raupach, M. R., et al., Proc Natl Acad Sci USA, 2007. 104(24): p. 10288-93.
2. Pacala, S. and R. Socolow, Science, 2004. 305: p. 968-971.
3. IPCC, Climate Change 2014: Synthesis Report, C. W. Team, R. K. Pachauri, and L. A. Meyer, Editors. 2014, IPCC: Geneva, Switzerland.
4. House, K. Z., et al., Energy & Environmental Science, 2009. 2(2): p. 193.
5. Lackner, K. S., et al., Proc. Natl. Acad. Sci. USA, 2012. 109(33): p. 13156-13162.
6. House, K. Z., et al., Proc Natl Acad Sci USA, 2011. 108(51): p. 20428-33.
7. Mahmoudkhani, M. and D. W. Keith, 2009. 3(4): p. 376-384.
8. Keith, D. W., et al., Joule, 2018.
9. Huskinson, B., et al., Nature, 2014. 505(7482): p. 195-8.
10. Lin, K., et al., Science, 2015. 349: p. 1529-1532.
11. Lin, K., et al., Nature Energy, 2016. 1(9): p. 16102.
12. Costentin, C., Chem. Rev., 2008. 108: p. 2145-2179.
13. Laviron, E., Journal of Electroanalytical Chemistry, 1984. 169: p. 29-46.
14. Quan, M., et al., Journal of American Chemical Society, 2007. 129: p. 12847-12856.
15. Zeebe, R. E. and D. Wolf-Gladrow, Elsevier Oceanography Series, ed. D. Halpern. Vol. 65. 2005, Amsterdam: Elsevier.
16. Roy, R. N., et al., Marine Chemistry, 1993. 44: p. 249-267.
17. Stolaroff, J. K., D. W. Keith, and G. V. Lowry, Environ Sci Technol, 2008. 42: p. 2728-2735.
18. Huynh, M. H. V. and T. J. Meyer, Chemical Reviews, 2007.107: p. 5004-5064.
19. Lin, K., et al., Science, 2015. 349(6255): p. 1529.
20. Yang, B., et al., Journal of The Electrochemical Society, 2016. 163(7): p. A1442-A1449.
21. Kwabi, D. G., et al., Joule, 2018. 2.
22. Hoober-Burkhardt, L., et al., Journal of the Electrochemical Society, 2017. 164(4): p. A600-A607.
23. Milshtein, J. D., et al., Electrochimica Acta, 2015. 180: p. 695-704.
24. Jackson, M. N., et al., J Am Chem Soc, 2018. 140(3): p. 1004-1010.
25. Hollas, A., et al., Nature Energy, 2018. 3(6): p. 508-514.
26. Pratt, H. D., et al., Journal of Power Sources, 2013. 236: p. 259-264.
27. Chen, J. J., M. D. Symes, and L. Cronin, Nat Chem, 2018.
28. Rausch, B., et al., Science, 2014. 345(6202): p. 1326-1330.
29. Krishnan, C. V., et al., International Journal of Electrochemical Science, 2007. 2: p. 29-51.
30. Holmes, G. and D. W. Keith, Philos Trans A Math Phys Eng Sci, 2012. 370(1974): p. 4380-403.
31. Varcoe, J. R., et al., Energy Environ. Sci., 2014. 7(10): p. 3135-3191.
32. Desai, D., et al., ACS Energy Letters, 2018. 3(2): p. 375-379.
33. Wong, A. A., M. J. Aziz, and S. M. Rubinstein, 2017, ECS Transactions: New Orleans, La.
34. Kok, M. D. R. and J. T. Gostick, Journal of Membrane Science, 2015. 473: p. 237-244.
35. Gerhardt, M. R., A. A. Wong, and M. J. Aziz, Journal of the Electrochemical Society, 2018. 165(11): p. A2625-A2643.
36. Lopes, T., et al., Journal of Power Sources, 2015. 274: p. 382-392.
37. Yin, C., et al., A coupled three dimensional model of vanadium redox flow battery for flow field designs. Energy, 2014. 74: p. 886-895.
38. Ke, X., et al., Journal of Power Sources, 2018. 384: p. 295-302.
39. Messaggi, M., et al., Applied Energy, 2018. 228: p. 1057-1070.
40. Watkins, J. D., et al., Energy & Fuels, 2015. 29(11): p. 7508-7515.
41. Chen, Q., M. R. Gerhardt, and M. J. Aziz, Journal of The Electrochemical Society, 2017. 164(6): p. A1126-A1132.
42. DeBruler, C., et al., ACS Energy Letters, 2018. 3(3): p. 663-668.
43. Gurkan, B., F. Simeon, and T. A. Hatton, ACS Sustainable Chemistry & Engineering, 2015. 3(7): p. 1394-1405.
44. Scovazzo, P., et al., Journal of The Electrochemical Society, 2003. 150(5): p. D91.
45. Al Sadat, W. I. and L. Archer, Science Advances, 2016. 2: p. 1-10.
46. Jackson, M. N., et al. Journal of the American Chemical Society, 2018, 140, p. 1004-1010.
47. Schulz, K. G., et al., Marine Chemistry, 2006. 100(1-2): p. 53-65.

Other embodiments are in the claims.

What is claimed is:

1. A device for capturing CO₂ comprising a liquid flow path comprising:
a) a first region comprising a first inlet and a first outlet and an aqueous solution or suspension comprising a proton-coupled redox active species, wherein the first region is configured to receive a gas comprising CO₂ via the first inlet, allow the gas to contact the aqueous solution or suspension, and to release the gas depleted of CO₂ via the first outlet;
b) a second region fluidically connected to the first region and comprising at least one electrode;
c) a third region fluidically connected to the second region and comprising a second outlet, wherein the third region is configured to release CO₂ outgassing from the aqueous solution or suspension via the second outlet; and
d) a fourth region fluidically connected to the first and third regions and comprising at least one electrode,
wherein oxidation of the proton-coupled redox active species releases one or more protons to decrease the pH of the aqueous solution or suspension and reduction of the proton-coupled redox active species takes up one or more protons to increase the pH of the aqueous solution or suspension.

2. The device of claim 1, further comprising an ion-conducting barrier disposed between the second and fourth regions.

3. The device of claim 1, wherein the third region further comprises a second inlet fluidically connected to the second outlet, wherein the second inlet is connected to a carrier gas source.

4. The device of claim 1, wherein the pH in the third region is less than 8.

5. The device of claim 1, wherein the pH in the first region is greater than 8.

6. The device of claim 1, wherein the proton-coupled redox active species is present in the aqueous solution or suspension at a concentration of at least 0.5 M.

7. The device of claim 1, wherein the oxidized form of the proton-coupled redox active species is a quinone, phenazine, alloxazine, isoalloxazine, or polyoxometalate.

8. The device of claim 1, wherein the device comprises an electrochemical cell.

9. The device of claim 1, wherein the device compromises a plurality of electrochemical cells.

10. A method of capturing CO₂, the method comprising the steps of:
a) providing an aqueous solution or suspension comprising a proton-coupled redox active species and having a first pH;
b) allowing a gas comprising CO₂ to contact the aqueous solution or suspension under conditions for the CO₂ to dissolve into the aqueous solution or suspension;
c) converting the pH of the aqueous solution or suspension to a second pH by oxidizing the proton-coupled redox active species;
d) allowing the dissolved CO₂ to outgas from the aqueous solution or suspension; and
e) converting the pH of the aqueous solution or suspension to a third pH by reducing the proton-coupled redox active species.

11. The method of claim 10, wherein the method is carried out in a device of any one of claims 1-9.

12. The method of claim 10, wherein the CO₂ is captured from a point source or ambient air.

13. The method of claim 10, wherein the second pH is less than 8.

14. The method of claim 10, wherein the third pH is greater than 6.

15. The method of claim 10, wherein the second pH is converted to the third pH in a single step.

16. The method of claim 10, wherein the second pH is converted to the third pH in two or more steps.

17. The method of claim 10, wherein the method operates continuously.

18. The method of claim 10, wherein the method operates sequentially.

19. The method of claim 10, wherein the oxidized form of the proton-coupled redox active species is a quinone, phenazine, alloxazine, isoalloxazine, or polyoxometalate.

20. The method of claim 10, wherein the oxidizing in step (b) and/or reducing in step (d) are carried out electrochemically.
